(19) United States
(12) Patent Application Publication
(10) Pub. No.: US 2012/0166098 A1
(43) Pub. Date: Jun. 28, 2012

(54) Methods for Optimizing Gradients in Liquid Chromatography Systems

(76) Inventors: Dennis McCreary, Greencastle, PA (US); Raaidah Saari-Nordhaus, Antioch (IL); James Anderson, Arlington Heights (IL); Adam Lesniowski, Linthicum, MD (US); Jeffrey McKown, Ellicott City, MD (US)

(21) Appl. No.: 13/262,756

(22) PCT Filed: Jan. 26, 2011
(86) PCT No.: PCT/US11/22513

§ 371 Date: Mar. 12, 2012

Related U.S. Application Data
(60) Provisional application No. 61/298,311, filed on Jan. 26, 2010.

(51) Int. Cl. G06F 17/10; G01N 30/02; G06G 7/57; G06F 19/00

(52) U.S. Cl. 702/25; 703/2

(57) ABSTRACT

Methods for determining one or more optimum gradient parameter values for the separation of components in liquid chromatography (LC) systems are disclosed. Liquid chromatography (LC) systems capable of determining one or more optimum gradient parameter values for the separation of components in a liquid chromatography column are also disclosed.

### FIELD OF THE INVENTION

The present invention is directed to methods for determining one or more optimum gradient parameter values for the separation of components in liquid chromatography (LC) systems. The present invention is directed to liquid chromatography (LC) systems capable of determining one or more optimum gradient parameter values for the separation of components in a liquid chromatography column.

### BACKGROUND OF THE INVENTION

A number of methods for optimizing separation of components in liquid chromatography systems are disclosed in the art. See, for example, P. Jandera, Journal of Chromatography A, 1126, 195-218 (2006), and P. Jandera, Journal of Chromatography A, 797, 11-22 (1998). In addition, there are a number of commercially available optimization software packages including, but not limited to, DRYLAB® software (Rheodyne, Rohnert Park, Calif.), CHROMDREAM® software (Iris Technologies, Lawrence, Kans.), CHROMSWORD® software (Iris Technologies, Lawrence, Kans.), and ELUEX™ software (CompuDrug Chemistry Ltd. (Budapest, Hungary). These systems or packages are not fully automated and do not provide for accurate, efficient, predictable and rapid fraction collection in liquid chromatography systems.

There is a need in the art for methods of determining one or more optimum gradient parameter values for the separation of components in liquid chromatography (LC) systems. Further, there is a need in the art for liquid chromatography (LC) systems capable of determining one or more optimum gradient parameter values for the separation of components in a liquid chromatography column.

### SUMMARY OF THE INVENTION

The present invention is directed to methods of determining one or more optimum gradient parameter values for the separation of components in liquid chromatography (LC) systems. The one or more optimum gradient parameter values may include, but are not limited to, a start gradient solvent volume concentration value, an end gradient solvent volume concentration value, a length of a gradient duration period, and combinations thereof. Use of one or more of the optimum gradient parameter values in a given liquid chromatography (LC) system may provide one or more potential benefits. Potential benefits include, but not limited to, separation of components in the shortest period of time, separation of components using less solvent, better separation of components, increased productivity from a given liquid chromatography (LC) system, reduced costs for separation, and combinations thereof.

In one exemplary embodiment, the method of determining one or more gradient parameter values for a liquid chromatography separation comprises utilizing retention data to estimate capacity factors, k's, of two or more elutable compounds using (i) a first separation comprising a first solvent volume concentration and (ii) a second separation comprising a second solvent volume concentration, wherein the second solvent volume concentration is different than the first solvent volume concentration; and utilizing the estimated capacity factors in combination with an optimum capacity factor value, kₒₚₜ, to determine (i) a start gradient solvent volume concentration value, and (ii) an end gradient solvent volume concentration value for the liquid chromatography separation.

The solvent volume concentration may refer to combinations of multi-component solvents such as acteonitrile with 0.1% trifluoric acid, aqueous buffers, etc. The solvents used in the first solvent volume concentration need not be the same as those in the second solvent volume concentration, for example hexane/ethyl acetate for the first and chloroform/methanol for the second. Any retention data may be utilized, including but not limited to, retention data from any of the common modes of techniques such as thin layger chromatography, liquid chromatography, size exclusion chromatography, supercritical fluid chromatography, simulated moving band chromatography, capillary electrophoresis chromatography, etc. The common modes for these techniques include ion exchange, reverse phase, normal phase, affinity, size exclusion, electromobility and others. In addition, any liquid chromatography method may be utilized to separate components in the present invention, including but not limited to, those listed above.

In another exemplary embodiment, a method of determining one or more gradient parameter values for a liquid chromatography separation includes utilizing chromatography retention data to estimate capacity factors of two or more elutable compounds; and utilizing the estimated capacity factors in combination with an optimum capacity factor value to determine (i) a start gradient solvent volume concentration value, and (ii) an end gradient solvent volume concentration value for the liquid chromatography separation.

In a further exemplary embodiment, a method of determining one or more gradient parameter values for a liquid chromatography separation includes utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes.

In one exemplary embodiment, the step of utilizing chromatography retention data to estimate capacity factors of two or more elutable compounds includes using (i) a first separation comprising a first solvent volume concentration and (ii) a second separation comprising a second solvent volume concentration, wherein the second solvent volume concentration is different than the first solvent volume concentration.

In an even further exemplary embodiment, a method of determining one or more gradient parameter values for a liquid chromatography separation includes utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one exemplary embodiment, the step of utilizing chromatography retention data to estimate capacity factors of two or more elutable compounds includes using (i) a first separation comprising a first solvent volume concentration and (ii) a second separation comprising a second solvent volume concentration, wherein the second solvent volume concentration is different than the first solvent volume concentration.

In another exemplary embodiment, the resolution may be recalculated by varying the start or end gradient solvent volume concentration values.

In another exemplary embodiment, the resolution is recalculated by varying gradient solvent duration volume.

In one exemplary embodiment, a computing system using software in a chromatography separation unit, wherein after resolution calculation is complete, gradient parameter values (times and concentrations table) are automatically provided to the chromatography unit or a user for separation of the compounds.

In a further exemplary embodiment, a method of determining one or more gradient parameter values for a liquid chromatography separation of elutable compounds may be performed by a computing system using software in a chromatography separation unit, wherein after a user inputs one or more properties of the elutable compounds into the computing system, the computing system provides the user with a recommended type of chromatography method, chromatography media, chromatography column size, and chromatography solvents to employ for separation of the elutable compounds.

In an even further exemplary embodiment, a method of separating two or more elutable compounds using liquid chromatography includes inputting one or more properties of the elutable compounds into a computing system in a chromatography separation unit, utilizing the computing system to generate gradient parameter values, automatically providing the gradient parameters to the chromatography separation unit or user, and separating the two or more elutable compounds.

In an even further exemplary embodiment, a method of separating two or more elutable compounds using liquid chromatography includes inputting one or more properties of the elutable compounds into a computing system in a liquid chromatography system; utilizing the computing system to generate recommended type of chromatography method, chromatography media, chromatography column size, and chromatography solvents to employ for separation of the elutable compounds; and utilizing the computing system to generate gradient parameters values. In another exemplary embodiment, the method of separating two or more elutable compounds using liquid chromatography further may include automatically providing the gradient parameters to the liquid chromatography system or a user; and separating the two or more elutable compounds.

In another exemplary embodiment, a method of separating two or more elutable compounds using liquid chromatography includes inputting chromatography retention data of the elutable compounds into a computing system in a liquid chromatography apparatus; utilizing the computing system to estimate capacity factors of the two or more elutable compounds; utilizing the computing system to determine whether the two or more elutable compounds will not separate with the estimated capacity factors; utilizing the computing system to generate at least one recommended type of chromatography method, chromatography media, chromatography column size, and chromatography solvents to employ for separation of the elutable compounds; and utilizing the at least one recommended type of chromatography method, chromatography media, chromatography column size, and chromatography solvents to separate the two or more elutable compounds.

In some exemplary embodiments, the method of determining one or more gradient parameter values for a liquid chromatography separation comprises separating a sample on a thin layer chromatography plate, the sample comprising two or more elutable compounds and a solvent system having a first solvent volume concentration; separating the same sample on another thin layer chromatography plate, using a solvent system having a second solvent volume concentration, wherein the second solvent volume concentration is greater than the first solvent volume concentration; calculating capacity factors, k's, for each of the two or more elutable compounds within the sample, wherein each k=(1−R_{f})/R_{f}, and R_{f} represents a retention factor for a given elutable compound in a given solvent system; utilizing the capacity factors, k's, and the first and second solvent volume concentrations to determine parameters (i) k₀ and m or (ii) a and m in at least one equation selected from: k=k₀φ^{-m} for a normal phase system, and ln k=a−mφ for a reverse phase system; and calculating initial start and end gradient solvent volume concentration values, φᵢₛ and φᵢₑ respectively, using an optimum capacity factor value, kₒₚₜ, and parameters (i) k₀ and m or (ii) a and m in at least one equation selected from: φ=[(k₀/kₒₚₜ)^{1/m}] for a normal phase system, and φ=[(a−ln kₒₚₜ)/m] for a reverse phase system.

The exemplary methods of determining one or more gradient parameter values for a liquid chromatography separation may further comprise a number of additional steps, as needed, to determine optimum gradient parameter values for a given liquid chromatography separation.

In some exemplary embodiments, additional steps include, but are not limited to, initiating a gradient duration period adjustment procedure, initiating a start gradient solvent volume concentration adjustment procedure, initiating an end gradient solvent volume concentration adjustment procedure, or any combination thereof.

The present invention is further directed to liquid chromatography (LC) optimization software capable of converting retention data inputted (e.g., data from thin layger chromatography, liquid chromatography, size exclusion chromatography, supercritical fluid chromatography, simulated moving band chromatography, capillary electrophoresis chromatography, etc.) into one or more optimized gradient parameter values, and providing the one or more optimized gradient parameter values to a user display and/or a liquid chromatography separation unit.

In one exemplary embodiment, the LC optimization software converts inputted TLC data in the form of R_{f} values for each component eluted on two separate TLC plates utilizing two different solvent concentrations into calculated capacity factors, k's, for each elutable compound at the two different solvent volume concentrations; and utilizing the calculated retention factors in combination with an optimum capacity factor value, kₒₚₜ, to determine (i) a start gradient solvent volume concentration value, and (ii) an end gradient solvent volume concentration value for a liquid chromatography system component. The LC optimization software may be utilized to provide an optimized gradient duration period, an optimized start gradient solvent volume concentration, an optimized end gradient solvent volume concentration, or any combination thereof.

The present invention is even further directed to liquid chromatography systems comprising a computing system, and a user interface with the computing system, wherein the computing system is capable of utilizing chromatography retention data to estimate capacity factors, k's, of at least two elutable compounds at two different solvent volume concentrations; and utilizing the estimated capacity factors in combination with an optimum capacity factor value, kₒₚₜ, to determine an optimized gradient duration period, an optimized start gradient solvent volume concentration, an optimized end gradient solvent volume concentration, or any combination thereof.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In some exemplary embodiments, the liquid chromatography system is capable of providing one or more separation parameter values to a user for a liquid chromatography separation, and comprises a computing system, and a user interface with the computing system, wherein the computing system is capable of utilizing retention data to estimate capacity factors, k's, of two or more elutable compounds; utilizing the estimated capacity factors in combination with an optimum capacity factor value, kₒₚₜ, to determine (i) a start gradient solvent volume concentration value, and (ii) an end gradient solvent volume concentration value for the liquid chromatography separation; and providing (i) the start gradient solvent volume concentration value, and (ii) the end gradient solvent volume concentration value to the user for review.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In an exemplary embodiment, a liquid chromatography system includes a computing system; and a user interface with the computing system; wherein the computing system is capable of utilizing chromatography retention data to estimate capacity factors of two or more elutable compounds; and utilizing the estimated capacity factors in combination with an optimum capacity factor value to determine (i) a start gradient solvent volume concentration value, and (ii) an end gradient solvent volume concentration value for the liquid chromatography separation.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In an exemplary embodiment, a liquid chromatography system includes a computing system, and a user interface with the computing system, wherein the computing system is capable of utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the retention volumes of each elutable compound.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In a further exemplary embodiment, a liquid chromatography system comprises a computing system, and a user interface with the computing system, wherein the computing system is capable of utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In one embodiment, the resolution may be recalculated by varying the start or end gradient solvent volume concentration values.

In another exemplary embodiment, the resolution is recalculated by varying gradient solvent duration volume. In one exemplary embodiment, a computing system using software in a chromatography separation unit, wherein after resolution calculation is complete, gradient parameter values (times and concentrations table) are automatically provided to the chromatography unit or user for separation of the compounds.

In another exemplary embodiment, a liquid chromatography system is capable of separating two or more elutable compounds with liquid chromatography using one or more properties of the elutable compounds input into a computing system in communication with the liquid chromatography system, capable of determining one or more gradient parameter values for a liquid chromatography separation of the elutable compounds performed by the computing system, and capable of providing the user with a recommended type of chromatography method, chromatography media, chromatography column size, and chromatography solvents to employ for separation of the elutable compounds after a user inputs one or more properties of the elutable compounds into the computing system.

In an exemplary embodiment, a liquid chromatography system includes a computing system; and a user interface with the computing system; wherein the liquid chromatography system is capable of (a) separating two or more elutable compounds with liquid chromatography using one or more properties of the elutable compounds input into a computing system, which is in communication with the liquid chromatography system; (b) determining one or more gradient parameter values for a liquid chromatography separation of the elutable compounds performed by the computing system; and (c) automatically providing the gradient parameters to the chromatography system or a user.

In a further exemplary embodiment, a liquid chromatography system is capable of separating two or more elutable compounds with liquid chromatography using one or more properties of the elutable compounds input into a computing system in communication with the liquid chromatography system, capable of determining one or more gradient parameter values for a liquid chromatography separation of the elutable compounds performed by the computing system, and capable of automatically providing the gradient parameters to the chromatography system or user.

In an exemplary embodiment, a liquid chromatography system includes a computing system; and a user interface with the computing system; wherein the liquid chromatography system is capable of (a) separating two or more elutable compounds with liquid chromatography using one or more properties of the elutable compounds input into a computing system, which is in communication with the liquid chromatography system; (b) utilizing the computing system to generate at least one recommended type of chromatography method, chromatography media, chromatography column size, and chromatography solvents to employ for separation of the elutable compounds; and (c) utilizing the computing system to determine one or more gradient parameter values for a liquid chromatography separation of the elutable compounds.

In one exemplary embodiment, the computing system is capable of recalculating the resolution by varying the start or end gradient solvent volume concentration values. In another exemplary embodiment, the computing system is capable of recalculating the resolution by varying gradient solvent duration volume.

In an even further exemplary embodiment, a liquid chromatography system is capable of separating two or more elutable compounds with liquid chromatography using one or more properties of the elutable compounds input into a computing system in communication with the liquid chromatography system, capable of determining one or more gradient parameter values for a liquid chromatography separation of the elutable compounds performed by the computing system, capable of automatically providing the gradient parameters to the chromatography system or user, and capable of utilizing the computing system to generate recommended type of chromatography method, chromatography media, chromatography column size, and chromatography solvents to employ for separation of the elutable compounds.

In an exemplary embodiment, a liquid chromatography system includes a computing system; and a user interface with the computing system; wherein the liquid chromatography system is capable of (a) separating two or more elutable compounds with liquid chromatography using one or more properties of the elutable compounds input into a computing system, which is in communication with the liquid chromatography system; (b) determining one or more gradient parameter values for a liquid chromatography separation of the elutable compounds performed by the computing system; and (c) providing the user with a recommended type of chromatography method, chromatography media, chromatography column size, and chromatography solvents to employ for separation of the elutable compounds after the user inputs one or more properties of the elutable compounds into the computing system.

In an exemplary embodiment, a liquid chromatography system includes a computing system; and a user interface with the computing system; wherein the liquid chromatography system is capable of (a) utilizing the computing system to estimate capacity factors of the two or more elutable compounds using retention data of the elutable compounds into a computing system; (b) utilizing the computing system to determine whether the two or more elutable compounds will not separate with the estimated capacity factors; (c) utilizing the computing system to generate at least one recommended type of chromatography method, chromatography media, chromatography column size, and chromatography solvents to employ for separation of the elutable compounds; and (d) utilizing the at least one recommended type of chromatography method, chromatography media, chromatography column size, and chromatography solvents to separate the two or more elutable compounds.

Liquid chromatography systems of the present invention may further comprise a liquid chromatography separation unit comprising a liquid chromatography column, a fraction collector, and liquid chromatography separation unit software, wherein the liquid chromatography separation unit software is operatively adapted to accept one or more of the optimized process parameters from the computing system so as to efficiently run a given LC sample.

The present invention is even further directed to computer readable medium having stored thereon computer-executable instructions for performing the disclosed methods of determining one or more gradient parameter values for a liquid chromatography separation. The computer readable medium may be utilized to load the computer-executable instructions onto a computing system capable of executing the computer-executable instructions.

These and other features and advantages of the present invention will become apparent after a review of the following detailed description of the disclosed embodiments and the appended claims.

### BRIEF DESCRIPTION OF THE FIGURES

FIG. 1 depicts a schematic diagram of an exemplary liquid chromatography (LC) system capable of providing one or more gradient parameter values to a user according to the present invention;

FIG. 2 graphically depicts starting gradient solvent volume concentration, ending gradient solvent volume concentration, and a gradient duration period for an exemplary liquid chromatography (LC) separation;

FIG. 3 depicts exemplary thin layer chromatography (TLC) retention factor measurements for an exemplary thin layer chromatography (TLC) separation;

FIGS. 4-6 depict a flow diagram of an exemplary method of determining one or more gradient parameter values for a liquid chromatography separation according to the present invention;

FIG. 7 depicts a flow diagram of exemplary method steps for initiating a start gradient solvent volume concentration adjustment procedure according to the present invention;

FIG. 8 depicts a flow diagram of exemplary method steps for initiating an end gradient solvent volume concentration adjustment procedure according to the present invention;

FIG. 9 depicts a flow diagram of an exemplary method of determining one or more gradient parameter values for a liquid chromatography separation according to the present invention utilizing a “speed process” mode selected by a user;

FIG. 10 depicts a flow diagram of an exemplary method of determining one or more gradient parameter values for a liquid chromatography separation according to the present invention utilizing a “purity process” or “purity process” mode selected by a user;

FIGS. 11 and 12 depict a flow diagram of an exemplary method of determining one or more gradient parameter values for a liquid chromatography separation according to the present invention;

FIG. 13 graphically depicts an actual separation of components using the optimized gradient procedure of the present invention as described in Example 1;

FIG. 14 graphically depicts an actual separation of components using the optimized gradient procedure of the present invention as described in Example 2;

FIG. 15 graphically depicts an actual separation of components using the optimized gradient procedure of the present invention as described in Example 3;

FIG. 16 graphically depicts an actual separation of components using the optimized gradient procedure of the present invention as described in Example 4; and

FIG. 17 graphically depicts an actual separation of components using the optimized gradient procedure of the present invention as described in Example 5.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “a solvent” includes a plurality of such solvents and reference to “solvent” includes reference to one or more solvents and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “chromatography” means a physical method of separation in which the components to be separated are distributed between two phases, one of which is stationary (stationary phase) while the other (the mobile phase) moves in a definite direction.

As used herein, the term “chromatography retention data” means information relating to the retention of an analyte (e.g., target substance or elutable compound) on a stationary phase or the like, and includes, but is not limited to, retention time, retention volume, R_{f} values for each elutable component, solvent composition and concentration, plate type, stationary phase, etc.

As used herein, the term “fluid” means a gas, liquid, and supercritical fluid.

As used herein, the term “gradient parameter value” means a value that relates to the solvent gradients used in the separation of components in liquid chromatography (LC) systems. Gradient parameter values may include, but are not limited to, a start gradient solvent volume concentration value, an end gradient solvent volume concentration value, a length of a gradient duration period, other gradient solvent concentration values, and combinations thereof.

As used herein, the term “liquid chromatography” means the separation of mixtures by passing a fluid mixture dissolved in a “mobile phase” through a column comprising a stationary phase, which separates the analyte (i.e., the target substance) from other molecules in the mixture and allows it to be isolated. Liquid chromatography methods may include but is not limited to, gravity flow, low pressure, medium pressure, high pressure, ultra high pressure, prep, process, etc.

As used herein, the term “properties” means chemical and physical properties of compounds that may be measured without destroying the chemical composition of the compound. For example, properties of elutable compounds include those that determine the conditions of a chromatography separation, such as, for example solubility, polarity, charge, counter ion, affinity, pH, dissociation constants, complexing characteristics, molecular size, dipole moment, electronegativity, chemical structure, etc.

As used herein, the term “stationary phase” means material fixed in the column or cartridge that selectively adsorbs the analyte from the sample in the mobile phase separation of mixtures by passing a fluid mixture dissolved in a “mobile phase” through a column comprising a stationary phase, which separates the analyte to be measured from other molecules in the mixture and allows it to be isolated.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

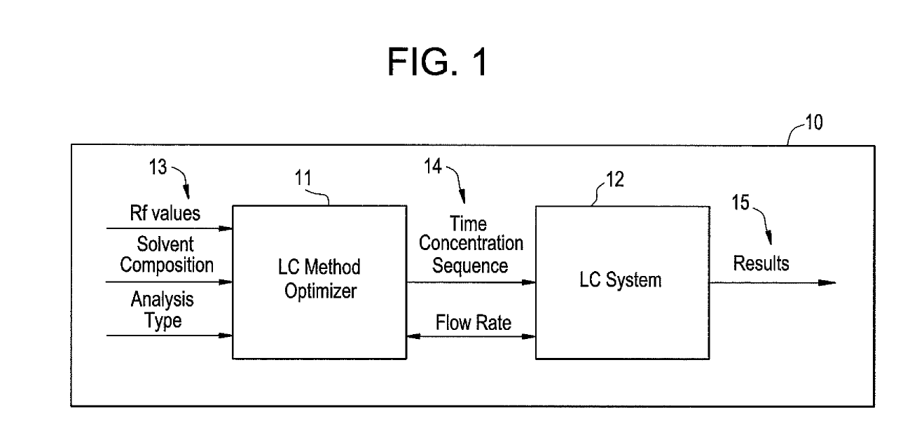

The present invention is directed to methods of determining one or more optimum gradient parameter values for the separation of components in liquid chromatography (LC) systems. The present invention is further directed to liquid chromatography (LC) systems capable of providing one or more gradient parameter values to a user for a given liquid chromatography separation. A schematic diagram of an exemplary liquid chromatography (LC) system capable of providing one or more gradient parameter values to a user according to the present invention is provided in FIG. 1.

As shown in FIG. 1, exemplary liquid chromatography (LC) system 10 comprises a LC method optimizer component 11, which accepts data 13 from a user (not shown), processes data 13, and provides one or more gradient parameter values 14 to a LC system component 12 and to a user (not shown) via a user interface, such as a display screen (not shown). The LC system component 12 then performs the separation of an actual sample and provides results 15 of the separation to a user (not shown) via a user interface, such as a display screen (not shown).

A further description of exemplary methods and liquid chromatography (LC) systems is provided below.

### I. Methods of Determining Optimum Gradient Parameter Values for LC Systems

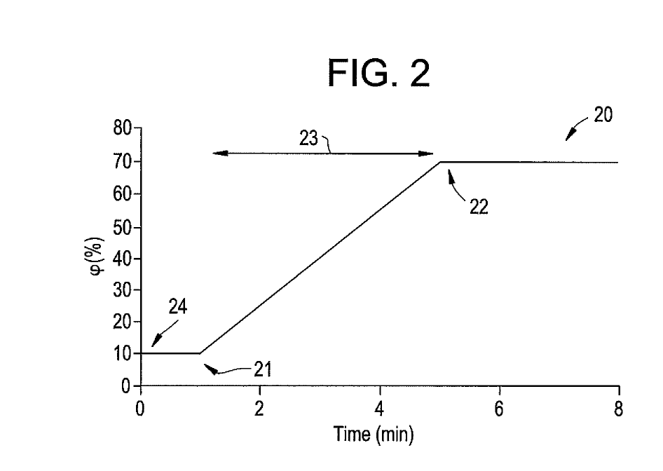

The present invention is directed to methods of determining one or more optimum gradient parameter values for the separation of components in liquid chromatography (LC) systems. The one or more optimum gradient parameter values may include, but are not limited to, a start gradient solvent volume concentration value, an end gradient solvent volume concentration value, a length of a gradient duration period, and combinations thereof. FIG. 2 graphically depicts several parameters that may be optimized using the methods of the present invention.

As shown in FIG. 2, graph 20 shows the change in a gradient solvent volume concentration value during a LC separation as shown by line 24. At time 0, gradient solvent volume concentration comprises a start gradient solvent volume concentration value 21. At a time greater than time 0, the gradient solvent volume concentration value enters a gradient duration period 23 during which the gradient solvent volume concentration value increases to an end gradient solvent volume concentration value 22. In some embodiments of the present invention, the disclosed methods determine start gradient solvent volume concentration value 21, end gradient solvent volume concentration value 22, and a length of gradient duration period 23 so as to optimize elution of components, while maintaining a desired level of resolution during the separation.

In another exemplary embodiment, a method of determining one or more gradient parameter values for a liquid chromatography separation includes utilizing chromatography retention data to estimate capacity factors of two or more elutable compounds; and utilizing the estimated capacity factors in combination with an optimum capacity factor value to determine (i) a start gradient solvent volume concentration value, and (ii) an end gradient solvent volume concentration value for the liquid chromatography separation. In one embodiment, the chromatography retention data is obtained using thin layer chromatography.

In another exemplary embodiment, the step of utilizing chromatography retention data to estimate capacity factors of the two or more elutable compounds comprises (i) a first separation comprising a first solvent volume concentration and (ii) a second separation comprising a second solvent volume concentration, wherein the second solvent volume concentration is different than the first solvent volume concentration. In an exemplary embodiment, the start and end gradient solvent volume concentration values may be utilized to calculate retention volumes of each elutable compound. In another exemplary embodiment, the retention volumes of each elutable compound are utilized to calculate resolution between each elutable compound.

In another exemplary embodiment, the method includes initiating a gradient duration adjustment procedure if the resolution between each elutable compound is not achieved. The gradient duration adjustment may comprise (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating a start gradient solvent concentration adjustment procedure. The start gradient solvent concentration adjustment procedure may comprise (a) decreasing the start gradient solvent volume concentration to a decreased start gradient solvent volume concentration value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating an end gradient solvent concentration adjustment procedure. The end gradient solvent concentration adjustment procedure may comprise (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In a further exemplary embodiment, a method of determining one or more gradient parameter values for a liquid chromatography separation includes utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes.

In one exemplary embodiment, the step of utilizing chromatography retention data to estimate capacity factors of two or more elutable compounds includes using (i) a first separation comprising a first solvent volume concentration and (ii) a second separation comprising a second solvent volume concentration, wherein the second solvent volume concentration is different than the first solvent volume concentration.

In another exemplary embodiment, the retention volumes of each elutable compound are utilized to calculate resolution between each elutable compound. In another exemplary embodiment, the method includes initiating a gradient duration adjustment procedure if the resolution between each elutable compound is not achieved. The gradient duration adjustment may comprise (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating a start gradient solvent concentration adjustment procedure. The start gradient solvent concentration adjustment procedure may comprise (a) decreasing the start gradient solvent volume concentration to a decreased start gradient solvent volume concentration value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating an end gradient solvent concentration adjustment procedure. The end gradient solvent concentration adjustment procedure may comprise (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In an even further exemplary embodiment, a method of determining one or more gradient parameter values for a liquid chromatography separation includes utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one exemplary embodiment, the step of utilizing chromatography retention data to estimate capacity factors of two or more elutable compounds includes using (i) a first separation comprising a first solvent volume concentration and (ii) a second separation comprising a second solvent volume concentration, wherein the second solvent volume concentration is different than the first solvent volume concentration.

In one embodiment, the resolution may be recalculated by varying the start or end gradient solvent volume concentration values.

In another exemplary embodiment, the resolution is recalculated by varying gradient solvent duration volume. In another exemplary embodiment, the method includes initiating a gradient duration adjustment procedure if the resolution between each elutable compound is not achieved. The gradient duration adjustment may comprise (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating a start gradient solvent concentration adjustment procedure. The start gradient solvent concentration adjustment procedure may comprise (a) decreasing the start gradient solvent volume concentration to a decreased start gradient solvent volume concentration value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating an end gradient solvent concentration adjustment procedure. The end gradient solvent concentration adjustment procedure may comprise (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In one exemplary embodiment, a computing system using software in a chromatography separation unit, wherein after resolution calculation is complete, gradient parameter values (times and concentrations table) are automatically provided to the chromatography unit or user for separation of the compounds.

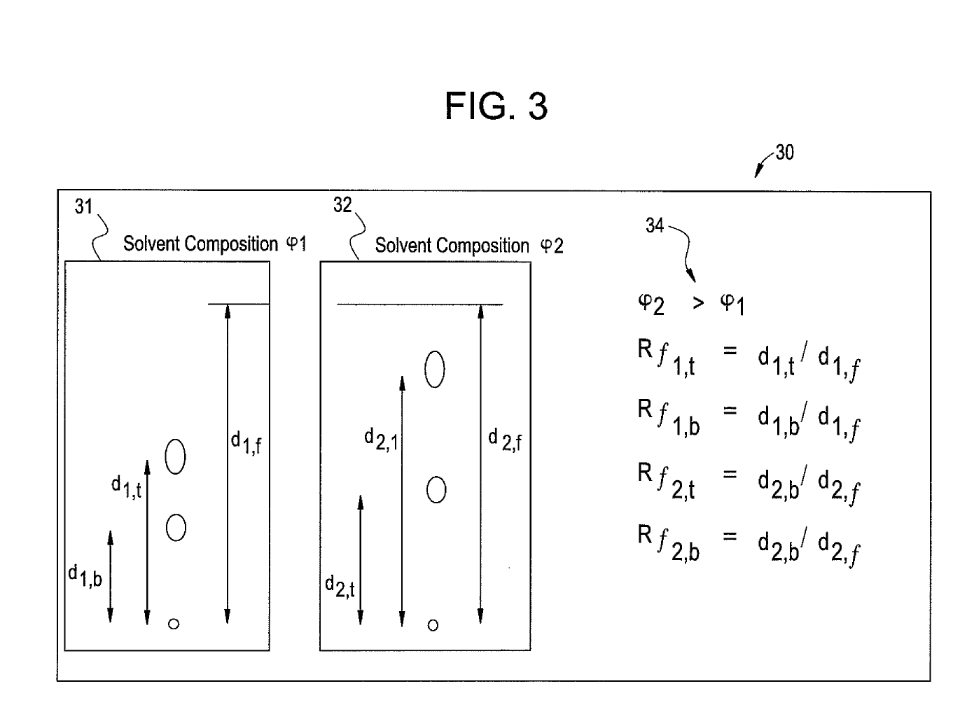

In one exemplary embodiment, a method of the present invention utilizes chromatography retention data (e.g., thin layer chromatography retention data) to determine one or more gradient parameter values for a liquid chromatography separation. In exemplary methods, thin layer chromatography data (e.g., R_{f} values for each elutable component, solvent composition and concentration, and plate type) is used to calculate capacity factors, k's, of at least two elutable compounds at two different solvent volume concentrations, where each k=(1−R_{f})/R_{f}, and R_{f} represents a retention factor for a given compound in a given solvent system. Such thin layer chromatography data is depicted in FIG. 3.

As shown in FIG. 3, exemplary thin layer chromatography (TLC) data 30 comprises retention factor measurements 34 for exemplary thin layer chromatography (TLC) plate runs 31 and 32 using (1) a first solvent composition value φ₁ (run 31) and (2) a second solvent composition value φ₂ (run 32). The calculated retention factors (i.e., Rf_{1,t}, Rf_{1,b}, Rf_{2,t}, and Rf_{2,b} shown in FIG. 3) are then used in combination with an optimum capacity factor value, kₒₚₜ, to determine (i) a start gradient solvent volume concentration value, and (ii) an end gradient solvent volume concentration value for a liquid chromatography system component (e.g., LC system component 12 shown in FIG. 1) as discussed further below. Even though FIG. 3 depicts a second solvent composition value to be greater than the second solvent composition value, the reverse is also contemplated herein.

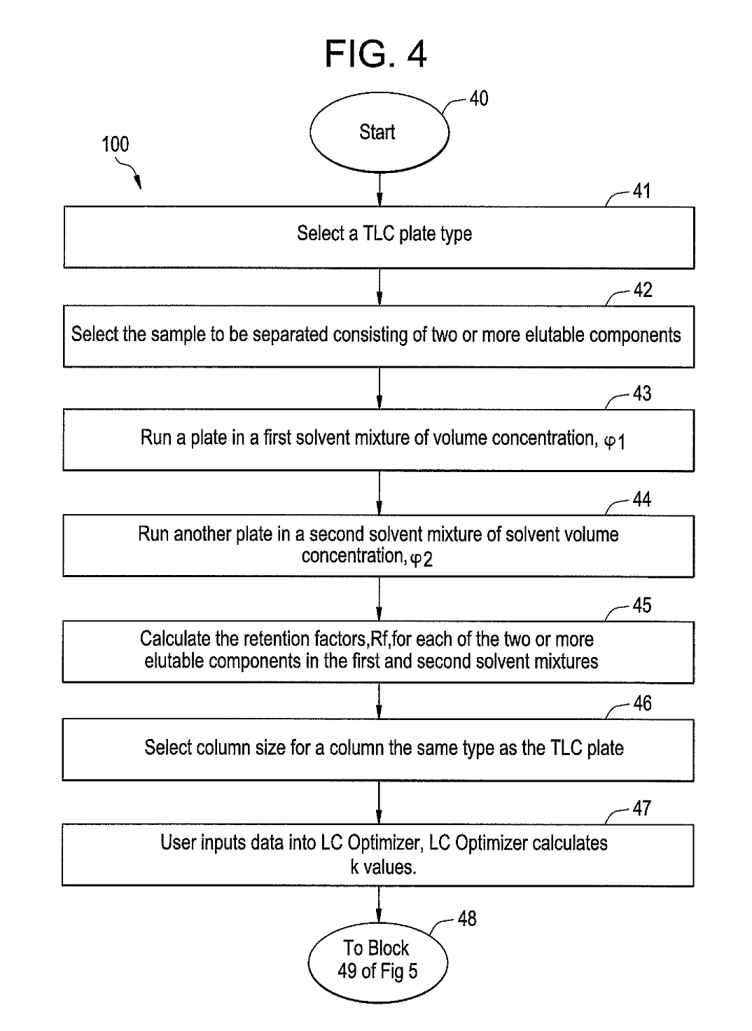

One exemplary method of determining one or more gradient parameter values for a liquid chromatography separation according to the present invention is depicted in FIGS. 4-6. As shown in FIG. 4, exemplary method 100 starts at block 40, and proceeds to step 41, wherein a TLC plate type (e.g., silica) is selected by a user. From step 41, exemplary method 100 proceeds to step 42, wherein a sample to be separated is selected by a user. The sample consists of two or more elutable components. From step 42, exemplary method 100 proceeds to step 43, wherein the sample is run on a TLC plate using a first solvent mixture having a volume concentration value φ₁. From step 43, exemplary method 100 proceeds to step 44, wherein the sample is run on another TLC plate using a second solvent mixture having a volume concentration value φ₂, wherein φ₂ is different than φ₁.

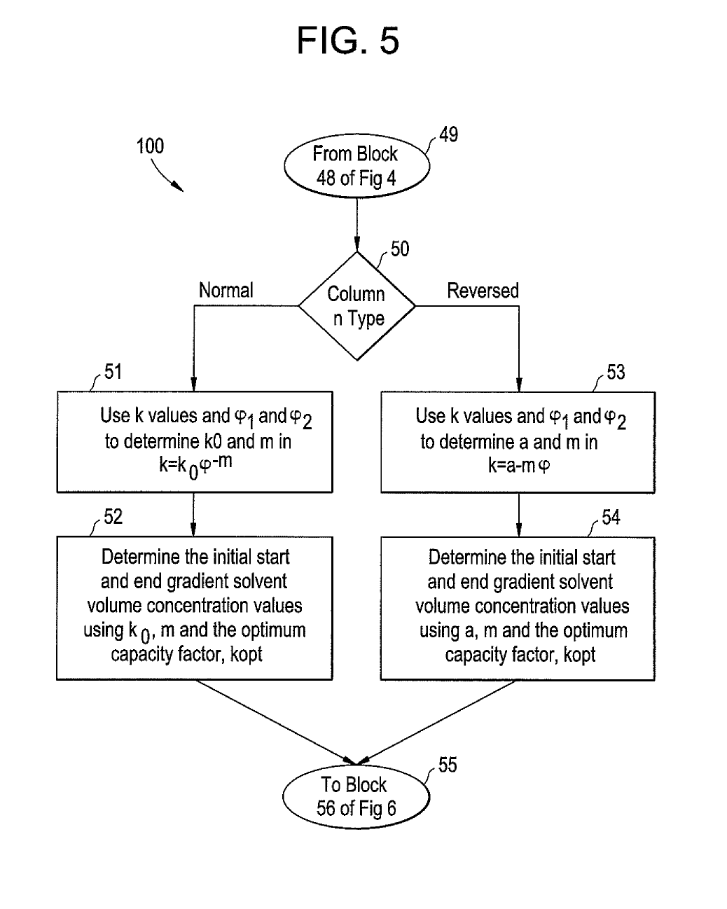

From step 44, exemplary method 100 proceeds to step 45, wherein retention factors, R_{f}, are calculated by the user for each of the two or more elutable components in each of the two solvent mixtures. From step 45, exemplary method 100 proceeds to step 46, wherein the user selects a column having (i) a desired size and (ii) type similar to the previously used TLC plate (e.g., silica). From step 46, exemplary method 100 proceeds to step 47, wherein the user inputs data into LC optimizer 11. Inputted data may include, but is not limited to, retention factors R_{f} calculated by the user; type of column (e.g., normal phase, reverse phase, etc); column size; flow rate; and first and second solvent volume concentration values φ₁ and φ₂ used during the two previous TLC runs. From the calculated retention factors R_{f}, LC optimizer 11 calculates capacity factors, k, where k=(1−R_{f})/R_{f}, and R_{f} represents a retention factor for a given elutable compound in each of the first and second solvent mixtures. From step 47, exemplary method 100 proceeds to block 48, wherein exemplary method 100 proceeds to block 49 shown in FIG. 5.

From block 49, exemplary method 100 proceeds to decision block 50. At decision block 50, a determination is made by LC optimizer 11, based on data entered in step 47, whether the upcoming liquid chromatography run (i.e., in LC system component 12 shown in FIG. 1) is to be performed as a normal phase run or a reverse phase run. If a determination is made at decision block 50 that the upcoming liquid chromatography run is to be performed as a normal phase run, exemplary method 100 proceeds to step 51, wherein parameters k₀ and m are fitted using equation k=k₀φ^{-m}, the calculated capacity factors, k, from step 47, and the first and second solvent volume concentrations entered in step 47. In other words, in step 51, LC optimizer 11 performs a linear least squares fit of the calculated k values and the inputted solvent volume concentration values using the equation k=k₀φ^{-m} to obtain values for parameters k₀ and m for each elutable component.

From step 51, exemplary method 100 proceeds to step 52, wherein initial start and end gradient solvent volume concentration values, φᵢₛ and φᵢₑ respectively, are calculated by LC optimizer 11 using the equation, φ=[(k₀/kₒₚₜ)^{1/m}], the previously calculated values for parameters k₀ and m, and an optimum capacity factor value, kₒₚₜ, which may be stored in LC optimizer 11 or inputted by a user in step 47 above. In this step, a solvent concentration calculated using parameters k₀ and m for the first eluting compound is designated the start gradient volume concentration, φᵢₛ, while a solvent concentration calculated using parameters k₀ and m for the second eluting compound is designated the end gradient volume concentration, φᵢₑ. In some exemplary embodiments, a value of 2.0 is (i) stored in LC optimizer 11 or (ii) selected and inputted by the user for optimum capacity factor value, kₒₚₜ. From step 52, exemplary method 100 proceeds to block 55 discussed below.

If a determination is made by LC optimizer 11 at decision block 50 that the upcoming liquid chromatography run (i.e., in LC system component 12 shown in FIG. 1) is to be performed as a reverse phase run, exemplary method 100 proceeds to step 53, wherein parameters a and m are fitted using equation in k=a−mφ, the previously calculated capacity factors, k, from step 47, and the first and second solvent volume concentrations entered in step 47. In other words, in step 53, LC optimizer 11 performs a linear least squares fit of the calculated k values and the inputted solvent volume concentration values using the equation in k=a−mφ to obtain values for parameters a and m for each elutable component.

From step 53, exemplary method 100 proceeds to step 54, wherein initial start and end gradient solvent volume concentration values, φᵢₛ and φᵢₑ respectively, are calculated by LC optimizer 11 using the equation, φ=[(a−ln kₒₚₜ)/m], the previously calculated values for parameters a and m, and kₒₚₜ discussed above. In this step, a calculated solvent concentration using parameters a and m for the first eluting compound is designated the start gradient volume concentration, φᵢₛ, while a calculated solvent concentration using parameters a and m for the second eluting compound is designated the end gradient volume concentration, φᵢₑ. As discussed above, in some exemplary embodiments, a value of 2.0 is (i) stored in LC optimizer 11 or (ii) selected and inputted (such as in step 47) by the user for optimum capacity factor value, kₒₚₜ. From step 54, exemplary method 100 proceeds to block 55.

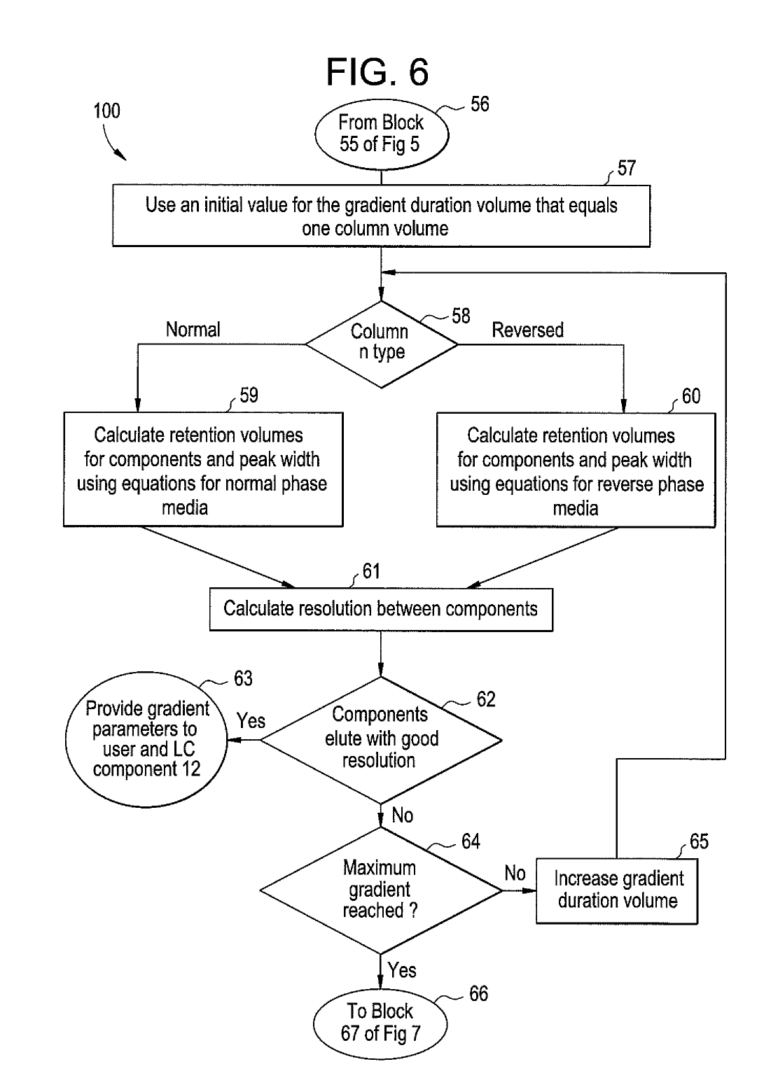

From block 55, exemplary method 100 proceeds to block 56 shown in FIG. 6. From block 56, exemplary method 100 proceeds to step 57, wherein an initial value equal to one column volume is utilized by LC optimizer 11 for the gradient duration period. It should be noted that LC optimizer 11 may utilize some other initial value for the initial gradient duration period at this step (i.e., two or more column volumes). From step 57, exemplary method 100 proceeds to decision block 58.

At decision block 58, a determination is made by LC optimizer 11, based on data entered in step 47, whether the upcoming liquid chromatography column (i.e., in LC system component 12 shown in FIG. 1) to be used is a normal phase or a reverse phase column. If a determination is made by LC optimizer 11 at decision block 58 that the chromatography run is to be performed using a normal phase column, exemplary method 100 proceeds to step 59, wherein retention volumes, V_{R}, for each elutable component, are calculated by LC optimizer 11 using equation I:

$${V}_{R} = {\frac{1}{B} [ ( m + 1 ) B ( {k}_{0} {V}_{m} - ( {V}_{D} + {V}_{h} ) {A}^{m} ) + {A}^{( m + 1 )} ]}^{1 / m + 1} - \frac{A}{B} + {V}_{m} {V}_{D} + {V}_{h} , \qquad ( I )$$

wherein:
m and kₒ are the previously calculated parameter from step 51;
A=the previously calculated start gradient volume concentration φᵢₛ from step 52;
B=[(the previously calculated end gradient volume concentration φᵢₑ from step 52)−(the previously calculated start gradient volume concentration φᵢₛ from step 52)]/(the gradient duration period);
Vₘ is the column volume (i.e., the void volume);
V_{D} is the dwell volume (i.e., the volume between the point at which the solvents mix and the head of the column); and
Vₕ is the initial hold volume.

It should be noted that Vₕ is a minimal value such that the first elutable component exits the column close to the beginning of the gradient. Vh is 0 to 1 times the flow rate. An arbitrary final hold volume is also chosen, for example 2(Vm+VD+Vh).

In step 59, LC optimizer 11 also calculates an average bandwidth of peaks of the two or more compounds, w_{g}, using equation II:

w_{g}=2(V₁+V₂)/\sqrt{N} (II),

wherein:
V₁ and V₂ are the V_{R}'s for elutable compounds 1 and 2 calculated using equation I above; and
N is the column efficiency.

From step 59, exemplary method 100 proceeds to step 61, wherein the resolution between component peaks is calculated. Typically, the resolution between component peaks is determined by equation III:

Rₛ=(V₂−V₁)/w_{g} (III).

As discussed further below, in some exemplary embodiments, the resolution (i.e., Rₛ as calculated by equation III) is desirably equal to at least about 1.5. From step 59, exemplary method 100 proceeds to decision block 62 discussed below.

Returning to decision block 58, if a determination is made at by LC optimizer 11, based on data entered in step 47, whether the upcoming liquid chromatography column (i.e., in LC system component 12 shown in FIG. 1) is to be performed using a reverse phase column, exemplary method 100 proceeds to step 60, wherein retention volumes, V_{R}, for each elutable component, are calculated by LC optimizer 11 using equation IV:

$${V}_{R} = ( \frac{1}{mB} ) ln \{ mB [ {V}_{m} {e}^{( a - mA )} - ( {V}_{D} + {V}_{h} ) ] + 1 \} + {V}_{m} + {V}_{D} + {V}_{h} , \qquad ( IV )$$

wherein:
m and a are the previously calculated parameter from step 53;
A=the previously calculated start gradient volume concentration φᵢₛ from step 54;
B=[(the previously calculated end gradient volume concentration φᵢₑ from step 54)−(the previously calculated start gradient volume concentration φᵢₛ from step 54)]/(the gradient duration period); and
Vₘ, V_{D} and Vₕ are volumes as described above with reference to equation I.

In step, 60, Vₕ is a minimal value as described above. In step 60, LC optimizer 11 also calculates w_{g} using equation II above.

From step 60, exemplary method 100 proceeds to step 61 wherein the resolution between component peaks is calculated using equation III above. From step 61, exemplary method 100 proceeds to decision block 62.

At decision block 62, a determination is made by LC optimizer 11 whether (i) the two or more elutable components elute completely (i.e., V₁<Vₘ+Vₕ+V_{D}+V_{G} and V₂<Vₘ+Vₕ+V_{D}+V_{G}) and (ii) a desired minimum resolution (e.g., Rₛ≦1.5 using equation III) is attained during a theoretical run using the previously calculated initial start and end gradient solvent volume concentration values (i.e., φᵢₛ and φᵢₑ from step 52 or 54) and the initial gradient duration period (i.e., one column volume). If a determination is made by LC optimizer 11 at decision block 62 that (i) the two or more elutable components elute completely and (ii) a desired minimum resolution is attained during the run, exemplary method 100 proceeds to step 63, wherein suggested gradient parameters, namely, start and end gradient solvent volume concentration values (i.e., φᵢₛ and φᵢₑ from step 52 or 54) and a gradient duration period length (i.e., the initial gradient duration period selected by the user, e.g., one column volume) are provided to a user, for example, via a display screen. The suggested gradient parameters may also be simultaneously provided to LC system component 12 by LC optimizer 11 in step 63 so that a user can simply accept the suggested gradient parameters and initiate a liquid chromatography run in LC system component 12 utilizing the suggested gradient parameters. Under the above conditions, exemplary method 100 ends at step 63.

Returning to decision block 62, if a determination is made by LC optimizer 11 at decision block 62 that either (i) the two or more elutable components do not elute completely (i.e., either V₁<Vₘ+Vₕ+V_{D}+V_{G} and V₂<Vₘ+Vₕ+V_{D}+V_{G}) or (ii) a desired minimum resolution is not attained (e.g., Rₛ<1.5 using equation III) during a theoretical run using the previously calculated initial start and end gradient solvent volume concentration values (i.e., φᵢₛ and φᵢₑ from step 52 or 54) and the initial gradient duration period (i.e., one column volume), exemplary method 100 proceeds to decision block 64. At decision block 64, a determination is made by LC optimizer 11 whether a predetermined maximum gradient duration volume has been utilized.

If a determination is made by LC optimizer 11 at decision block 64 that a predetermined maximum gradient duration volume has not yet been utilized (e.g., 10 column volumes), exemplary method 100 proceeds to step 65, wherein LC optimizer 11 increases the gradient duration volume (e.g., by one or more column volumes). From step 65, exemplary method 100 returns to decision block 58, and proceeds as discussed above. It should be noted that step 65 and subsequent steps are referred to herein as a gradient duration period value adjustment procedure.

In some embodiments such as in exemplary method 100, during the gradient duration period value adjustment procedure, the gradient duration volume is iteratively increased from an initial value of, for example, one column volume to a maximum of 10 column volumes in increments of one column volume. The predetermined maximum column volumes may vary depending upon the purity desired. At each value of gradient duration volume, exemplary method 100 checks to see if the two or more elutable components are completely eluted (i.e., V₁<Vₘ+Vₕ+V_{D}+V_{G} and V₂<Vₘ+Vₕ+V_{D}+V_{G}) and if the calculated resolution (i.e., Rₛ using equation III) is greater than a desired amount, e.g., 1.5, based on the V_{R}'s of the components. If both conditions are met before reaching a predetermined maximum column volume (e.g., 10 column volumes), exemplary method 100 proceeds to step 63 as discussed above.

In some embodiments, a user may choose to stop exemplary method 100 when either (1) both conditions, i.e., complete elution and desired resolution, are met or (2) the duration volume is equal to the predetermined column volume (e.g., 10 column volumes). In such a case, the user may further choose to initiate a liquid chromatography run in LC system component 12 using the previously calculated initial start and end gradient solvent volume concentration values (i.e., φᵢₛ and φᵢₑ from step 52 or 54) and the final gradient duration period (e.g., 1 to 10 or 15 column volumes).

Discussed further below, the user may select a “speed mode” option early in exemplary method 100 (e.g., at step 47). In the speed mode, LC optimizer 11 stops at step 63 or step 66, and outputs the start gradient volume concentration, the end gradient volume concentration and the gradient duration period to the user and LC system component 12.

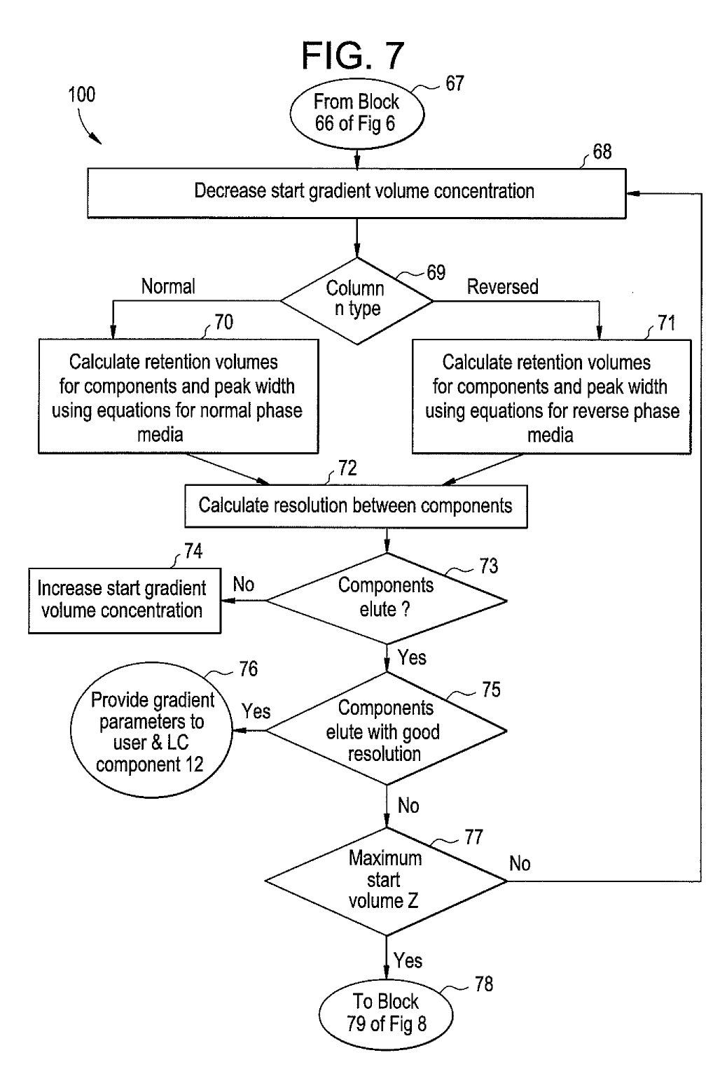

Returning to decision block 64, if a determination is made by LC optimizer 11 at decision block 64 that a predetermined maximum gradient duration volume has been utilized (e.g., 10 column volumes) and a “purity mode” option was selected (e.g. at step 47), exemplary method 100 proceeds to block 66. From block 66, exemplary method 100 proceeds to block 67 shown in FIG. 7, wherein a start gradient solvent volume concentration value adjustment procedure is initiated.

As shown in FIG. 7, exemplary method 100 proceeds from block 67 to step 68, wherein the previously used start gradient solvent volume concentration value (e.g., the initial start gradient solvent volume concentration value) is decreased by LC optimizer 11 by a set amount to a decreased start gradient solvent volume concentration value. In some embodiments, a given start gradient solvent volume concentration value is decreased by a set amount equal to about 10%. From step 68, exemplary method 100 proceeds to decision block 69. At decision block 69, a determination is made by LC optimizer 11, based on data entered in step 47, whether the chromatography column to be used is a normal phase or a reverse phase column. If a determination is made by LC optimizer 11 at decision block 69 that the chromatography run (i.e., in LC system component 12 shown in FIG. 1) is to be performed using a normal phase column, exemplary method 100 proceeds to step 70, wherein retention volumes and peak widths are calculated using equations I and II above wherein:
m and kₒ are the previously calculated parameter from step 51;
A=the decreased start gradient volume concentration φᵢₛ from step 68;
B=[(the previously calculated end gradient volume concentration φᵢₑ from step 52)−(the decreased start gradient volume concentration φᵢₛ from step 68)]/(the gradient duration period); and
Vₘ, V_{D} and Vₕ are as defined above for equation I.

From step 70, exemplary method 100 proceeds to step 72, wherein the resolution between component peaks is calculated using equation III above. From step 72, exemplary method 100 proceeds to decision block 73 discussed below.

Returning to decision block 69, if a determination is made by LC optimizer 11 at decision block 69 that the chromatography run is to be performed using a reverse phase column, exemplary method 100 proceeds to step 71, wherein retention volumes and peak widths are calculated using equations IV and II above wherein:
m and a are the previously calculated parameter from step 53;
A=the decreased start gradient volume concentration φᵢₛ from step 68;
B=[(the previously calculated end gradient volume concentration φᵢₑ from step 52)−(the decreased start gradient volume concentration φᵢₛ from step 68)]/(the gradient duration period); and
Vₘ, V_{D} and Vₕ are as defined above for equation IV.

From step 71, exemplary method 100 proceeds to step 72, wherein the resolution between component peaks is calculated using equation III above. From step 72, exemplary method 100 proceeds to decision block 73.

At decision block 73, a determination is made by LC optimizer 11 whether the two or more elutable components elute completely (i.e., V₁<Vₘ+Vₕ+V_{D}+V_{G} and V₂<Vₘ+Vₕ+V_{D}+V_{G}). If a determination is made by LC optimizer 11 at decision block 73 that the two or more elutable components elute completely, exemplary method 100 proceeds to decision block 75, wherein a determination is made whether the two or more elutable components elute completely (i.e., V₁<Vₘ+Vₕ+V_{D}+V_{G} and V₂<Vₘ+Vₕ+V_{D}+V_{G}) with a desired minimum resolution (e.g., Rₛ≦1.5 using equation III). If a determination is made by LC optimizer 11 at decision block 75 that the two or more elutable components elute completely with a desired minimum resolution, exemplary method 100 proceeds to step 76, wherein suggested gradient parameters, namely, the decreased start gradient solvent volume concentration value, the initial end gradient solvent volume concentration value, and the increased gradient duration period length are provided to a user, for example, via a display screen.

The suggested gradient parameters may also be simultaneously provided to LC system component 12 by LC optimizer 11 in step 76 so that a user can simply accept the suggested gradient parameters and initiate a liquid chromatography run in LC system component 12 utilizing the suggested gradient parameters. Under the above conditions, exemplary method 100 ends at step 76.

If a determination is made by LC optimizer 11 at decision block 75 that the two or more elutable components elute completely (i.e., V₁<Vₘ+Vₕ, +V_{D}+V_{G} and V₂<Vₘ+Vₕ+V_{D}+V_{G}), but do not exhibit a desired minimum resolution (e.g., Rₛ<1.5 using equation III), exemplary method 100 proceeds to decision block 77, wherein a determination is made by LC optimizer 11 whether a predetermined minimum start gradient volume concentration value has been utilized. If a determination is made by LC optimizer 11 at decision block 77 that a predetermined minimum start gradient volume concentration value has not yet been utilized, exemplary method 100 returns to step 68 and proceeds as discussed above and below.

In some exemplary embodiments such as exemplary method 100, the start gradient volume concentration is iteratively decreased by 10% (i.e., start value*0.9) a maximum of 100 times. At each value of the start gradient volume concentration, LC optimizer 11 checks to see if the two or more elutable components are completely eluted (i.e., V₁<Vₘ+Vₕ+V_{D}+V_{G} and V₂<Vₘ+Vₕ+V_{D}+V_{G}) and if the calculated resolution (i.e., Rₛ using equation III) is greater than a desired amount, e.g., 1.5, based on the V_{R}'s of the components. If both conditions are met before reaching a maximum number of start gradient volume concentration values (e.g., 100), exemplary method 100 proceeds to step 76 as discussed above. If both conditions are not met before reaching a maximum number of start gradient volume concentration values (e.g., 100), exemplary method 100 proceeds to step 78 as discussed below.

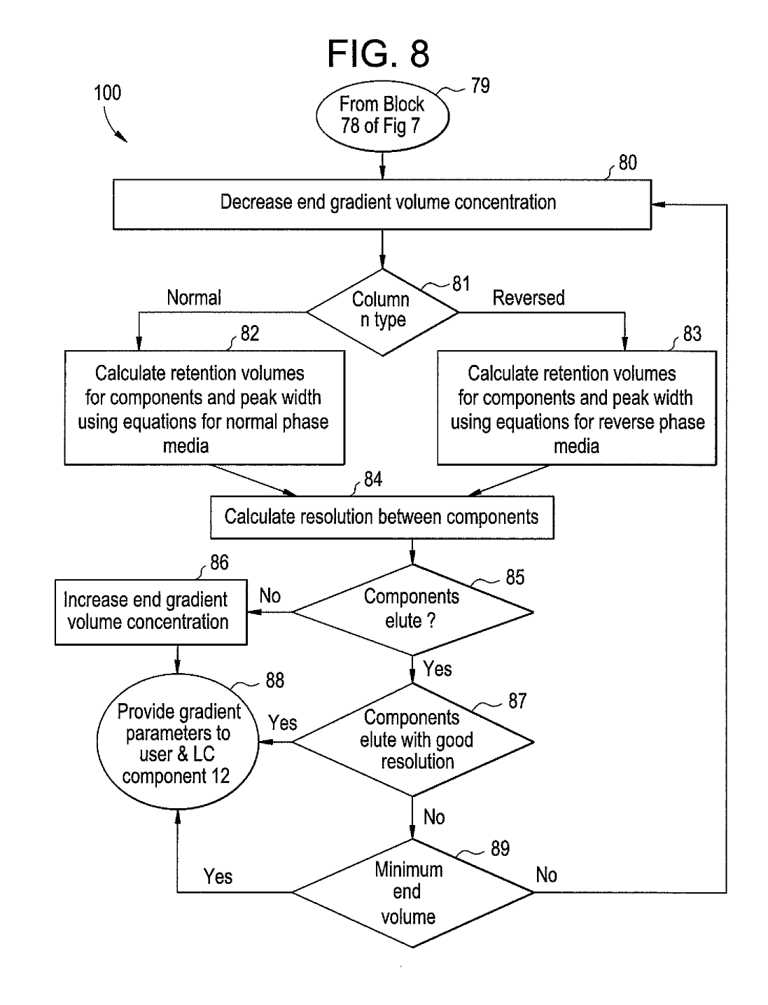

If a determination is made by LC optimizer 11 at decision block 77 that a predetermined minimum start gradient volume concentration value has been utilized (i.e., a maximum number of iterative decreases has been reached), exemplary method 100 proceeds to block 78. From block 78, exemplary method 100 proceeds to block 79 shown in FIG. 8 where an end gradient solvent volume concentration value adjustment procedure is initiated by LC optimizer 11 as discussed further below.

Returning to decision block 73, if a determination is made by LC optimizer 11 at decision block 73 that the two or more elutable components do not elute completely, exemplary method 100 proceeds to step 74, wherein the start gradient solvent volume concentration value is increased, typically to a previous start gradient solvent volume concentration value (e.g., the initial start gradient solvent volume concentration value or a previous decreased start gradient solvent volume concentration value). From step 74, exemplary method 100 proceeds to block 78. From block 78, exemplary method 100 proceeds to block 79 shown in FIG. 8 where an end gradient solvent volume concentration value adjustment procedure is initiated by LC optimizer 11.

As shown in FIG. 8, exemplary method 100 proceeds from block 79 to step 80, wherein the previously used end gradient solvent volume concentration value (e.g., the initial or decreased end gradient solvent volume concentration value) is decreased by LC optimizer 11 by a set amount to a decreased end gradient solvent volume concentration value. In some embodiments, a given end gradient solvent volume concentration value is decreased by a set amount equal to about 10%. From step 80, exemplary method 100 proceeds to decision block 81.

At decision block 81, a determination is made by LC optimizer 11, based on data entered in step 47, whether the chromatography column (i.e., in LC system component 12 shown in FIG. 1) to be used is a normal phase or a reverse phase column. If a determination is made by LC optimizer 11 at decision block 81 that the chromatography run is to be performed using a normal phase column, exemplary method 100 proceeds to step 82, wherein retention volumes and peak widths are calculated using equations I and II above wherein:
m and kₒ are the previously calculated parameter from step 51;
A=the previously calculated initial start gradient volume concentration φᵢₑ from step 52 or the decreased start gradient volume concentration φᵢₑ from step 68;
B=[(the decreased end gradient volume concentration φᵢₑ from step 80)−(the previously calculated initial start gradient volume concentration φᵢₑ from step 52 or the decreased start gradient volume concentration φᵢₛ from step 68)]/(the gradient duration period ranging from 1 to 15 column volumes); and
Vₘ, V_{D} and Vₕ are as defined above for equation I.

From step 82, exemplary method 100 proceeds to step 84, wherein the resolution between component peaks is calculated using equation III as discussed above. From step 84, exemplary method 100 proceeds to decision block 85 discussed below.

Returning to decision block 81, if a determination is made by LC optimizer 11 at decision block 81 that the chromatography run is to be performed using a reverse phase column, exemplary method 100 proceeds to step 83, wherein retention volumes and peak widths are calculated using equations IV and II above wherein:
m and a are the previously calculated parameter from step 53;
A=the previously calculated initial start gradient volume concentration φᵢₑ from step 52 or the decreased start gradient volume concentration φᵢₛ from step 68;
B=[(the decreased end gradient volume concentration φᵢₑ from step 80)−(the previously calculated initial start gradient volume concentration φᵢₑ from step 52 or the decreased start gradient volume concentration φᵢₛ from step 68)]/(the gradient duration period ranging from 1 to 15 column volumes); and
Vₘ, V_{D} and Vₕ are as defined above for equation IV.

From step 83, exemplary method 100 proceeds to step 84, wherein the resolution between component peaks is calculated using equation III as discussed above. From step 84, exemplary method 100 proceeds to decision block 85.

At decision block 85, a determination is made by LC optimizer 11 whether the two or more elutable components elute completely. If a determination is made by LC optimizer 11 at decision block 85 that the two or more elutable components do not elute completely (i.e., either V₁<Vₘ+Vₕ+V_{D}+V_{G} and V₂<Vₘ+Vₕ+V_{D}+V_{G}), exemplary method 100 proceeds to step 86, wherein the end gradient solvent volume concentration value is increased, typically to a previous end gradient solvent volume concentration value (e.g., the initial end gradient solvent volume concentration value or a previous decreased end gradient solvent volume concentration value).

From step 86, exemplary method 100 proceeds to step 88, wherein suggested gradient parameters, namely, the initial or decreased start gradient solvent volume concentration value, the initial or decreased end gradient solvent volume concentration value, and the increased gradient duration period length are provided to a user, for example, via a display screen, to accept or modify. The suggested gradient parameters may also be simultaneously provided to LC system component 12 by LC optimizer 11 in step 86 so that a user can simply accept the suggested gradient parameters and initiate a liquid chromatography run in LC system component 12 utilizing the suggested gradient parameters. Under the above conditions, exemplary method 100 ends at step 88.

Returning to decision block 85, if a determination is made by LC optimizer 11 at decision block 85 that the two or more elutable components do elute completely (i.e., V₁<Vₘ+Vₕ+V_{D}+V_{G} and V₂<Vₘ+Vₕ+V_{D}+V_{G}), exemplary method 100 proceeds to decision block 87, wherein a determination is made by LC optimizer 11 whether the two or more elutable components elute completely with a desired minimum resolution. If a determination is made at decision block 87 that the two or more elutable components elute completely with a desired minimum resolution (e.g., Rₛ≦1.5 using equation III), exemplary method 100 proceeds to step 88, wherein suggested gradient parameters, namely, the initial or decreased start gradient solvent volume concentration value, the decreased end gradient solvent volume concentration value, and the increased gradient duration period length are provided to a user, and optionally LC system component 12. Under the above conditions, exemplary method 100 ends at step 88.

If a determination is made by LC optimizer 11 at decision block 87 that the two or more elutable components elute completely (i.e., V₁<Vₘ+Vₕ+V_{D}+V_{G} and V₂<Vₘ+Vₕ+V_{D}+V_{G}), but do not exhibit a desired minimum resolution (e.g., Rₛ<1.5 using equation III), exemplary method 100 proceeds to decision block 89, wherein a determination is made by LC optimizer 11 whether a predetermined minimum end gradient volume concentration value has been utilized. If a determination is made by LC optimizer 11 at decision block 89 that a predetermined minimum end gradient volume concentration value has not yet been utilized, exemplary method 100 returns to step 80 and proceeds as discussed above and below.

In some exemplary embodiments such as exemplary method 100, the end gradient volume concentration is iteratively decreased by 10% (i.e., start value*0.9) a maximum of 100 times. At each value of the end gradient volume concentration, LC optimizer 11 checks to see if the two or more elutable components are completely eluted (i.e., V₁<Vₘ+Vₕ+V_{D}+V_{G} and V₂<Vₘ+Vₕ+V_{D}+V_{G}) and if the calculated resolution (i.e., Rₛ using equation III) is greater than a desired amount, e.g., 1.5, based on the V_{R}'s of the components. If both conditions are met before reaching a maximum number of end gradient volume concentration values (e.g., 100), exemplary method 100 proceeds to step 88 as discussed above. If both conditions are not met before reaching a maximum number of end gradient volume concentration values (e.g., 100), exemplary method 100 proceeds to step 89 as discussed below.

If a determination is made by LC optimizer 11 at decision block 89 that a predetermined minimum end gradient volume concentration value has been utilized, exemplary method 100 proceeds to step 88, wherein suggested gradient parameters, namely, the initial or decreased start gradient solvent volume concentration value, the decreased end gradient solvent volume concentration value, and the increased gradient duration period length are provided to a user to accept or modify, and optionally to LC system component 12. Under the above conditions, exemplary method 100 ends at step 88.

It should be noted that although exemplary method 100 follows a certain progression of method steps (i.e., initiating an optional gradient duration period adjustment procedure, then initiating an optional start gradient solvent volume concentration adjustment procedure, and subsequently initiating an optional end gradient solvent volume concentration adjustment procedure as needed), variations of exemplary method 100 are also within the scope of the present invention. For example, other methods of the present invention may follow other progressions of method steps, namely, initiation of an optional start gradient solvent volume concentration adjustment procedure and/or an optional end gradient solvent volume concentration adjustment procedure prior to an optional gradient duration period adjustment procedure.

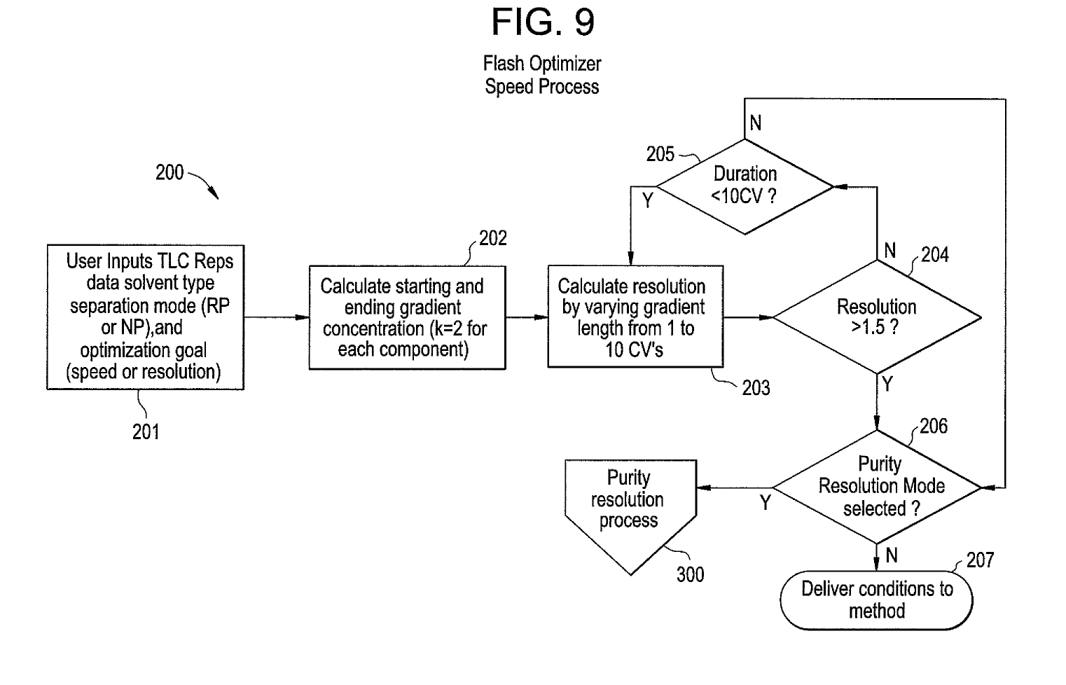

As noted above, a user may select a “speed process” mode for LC optimizer 11. Such a process is depicted in FIG. 9. As shown in FIG. 9, exemplary method 200 starts at step 201, wherein a user inputs chromatography retention data (e.g., retention factors R_{f} calculated by the user; first and second solvent composition and volume concentration values φ₁ and φ₂ used during two previous TLC runs; and plate type), separation mode (i.e., normal or reverse phase), and optimization goal (i.e., speed or resolution mode) into LC optimizer 11. From step 201, exemplary method 200 proceeds to step 202, wherein initial start and end gradient solvent volume concentration values, φᵢₛ and φᵢₑ respectively, are calculated by LC optimizer 11 using either equation (i) φ=[(k₀/kₒₚₜ)^{1/m}] for a normal phase or (ii) φ=[(a−ln kₒₚₜ)/m] for a reverse phase, previously calculated values for parameters k₀ and m or m and a, and an optimum capacity factor value, kₒₚₜ, which may be stored in LC optimizer 11 or inputted by a user in step 201 as discussed above.

From step 202, exemplary method 200 proceeds to step 203, wherein retention volumes and resolution are calculated by LC optimizer 11 as described above using equations I or IV and III for a given gradient period value (e.g., initially 1 column volume). From step 203, exemplary method 200 proceeds to decision block 204, wherein a determination is made by LC optimizer H whether (i) the two or more elutable components elute completely (i.e., V₁<Vₘ+Vₕ+V_{D}+V_{G} and V₂<Vₘ+Vₕ+V_{D}+V_{G} using equation I or IV above) and (ii) a desired minimum resolution (e.g., Rₛ>1.5 using equation III above) is attained during a theoretical run using the previously calculated initial start and end gradient solvent volume concentration values (i.e., φᵢₛ and φᵢₑ from step 202) and an initial gradient duration period (i.e., one column volume).

If a determination is made by LC optimizer 11 at decision block 204 that a desired minimum resolution is not attained (e.g., Rₛ<1.5 using equation III) during a theoretical run using the previously calculated initial start and end gradient solvent volume concentration values (i.e., φᵢₛ and φᵢₑ from step 202) and the initial gradient duration period (i.e., one column volume), exemplary method 200 proceeds to decision block 205. At decision block 205, a determination is made by LC optimizer 11 whether the gradient duration period is less than a predetermined gradient duration volume (e.g., 10 column volumes).

If a determination is made by LC optimizer 11 at decision block 205 that the gradient duration period is less than a predetermined gradient duration volume (e.g., 10 column volumes), exemplary method 200 returns to step 203, wherein LC optimizer 11 increases the gradient duration volume (e.g., by one column volume) and recalculates retention volumes and resolution as described above using equations I or IV and III for the increased gradient period value (e.g., 2 to 10 column volumes). From step 203, exemplary method 200 continues as described above and below.

Returning to decision block 205, if a determination is made by LC optimizer 11 at decision block 205 that the gradient duration period is equal to a predetermined gradient duration volume (e.g., 10 column volumes), exemplary method 200 proceeds to decision block 206, wherein LC optimizer 11 determines whether the purity mode or speed mode has been selected by the user. If LC optimizer 11 determines that the speed mode has been selected by the user (i.e., the purity mode has not been selected by the user), exemplary method 200 proceeds to step 207, wherein LC optimizer 11 provides optimized processing conditions to the user and LC system component 12.

Returning to decision block 204, if a determination is made by LC optimizer 11 that a desired minimum resolution is attained (e.g., Rₛ>1.5 using equation III) during a theoretical run using the previously calculated initial start and end gradient solvent volume concentration values (i.e., φᵢₛ and φᵢₑ from step 202) and a given gradient duration period (e.g., 1 to 10 column volumes), exemplary method 200 proceeds to decision block 206 and proceeds as discussed above and below.

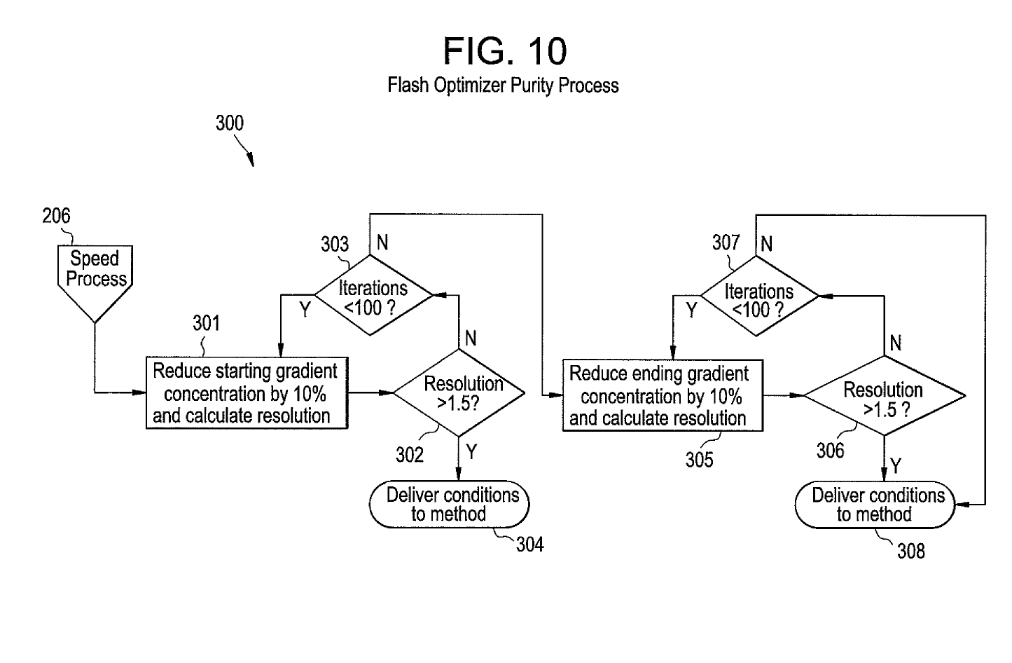

Returning to decision block 206, if a determination is made by LC optimizer 11 that the speed mode has not been selected by the user (i.e., the purity mode has been selected by the user), exemplary method 200 proceeds to purity mode process 300, wherein LC optimizer 11 initiates a purity mode further described in FIG. 10.

Instead of selecting a speed mode, a user may select a purity mode or process as depicted in FIG. 10. As shown in FIG. 10, exemplary method 300 starts with exemplary process 200 as described above, and is a continuation of exemplary process 200 from decision block 206. From decision block 206, exemplary process 300 proceeds to step 301, wherein LC optimizer 11 (1) reduces the starting gradient concentration by 10%, and (2) calculates retention volumes and resolution as described above using equations I or IV and III and the decreased start gradient solvent volume concentration value from step 301, the previously calculated end gradient solvent volume concentration value from step 202, and a predetermined gradient duration period of (e.g., 10 column volumes).

From step 301, exemplary method 300 proceeds to decision block 302, wherein a determination is made by LC optimizer 11 whether (i) the two or more elutable components elute completely (i.e., V₁<Vₘ+Vₕ+V_{D}+V_{G} and V₂<Vₘ+Vₕ+V_{D}+V_{G} using equation I or IV above) and (ii) a desired minimum resolution (e.g., Rₛ>1.5 using equation III above) is attained during a theoretical run using the previously calculated initial start and end gradient solvent volume concentration values (i.e., φᵢₛ and φᵢₑ from step 202) and a predetermined gradient period value (e.g., 10 column volumes).

If a determination is made by LC optimizer 11 at decision block 302 that a desired minimum resolution is not attained (e.g., Rₛ<1.5 using equation DT) during a theoretical run using the decreased start gradient solvent volume concentration value from step 301, the previously calculated end gradient solvent volume concentration value from step 202, and a predetermined gradient duration period (e.g., 10 column volumes), exemplary method 300 proceeds to decision block 303. At decision block 303, a determination is made by LC optimizer 11 whether the start gradient solvent volume concentration value has been decreased less than 100 times.

If a determination is made by LC optimizer 11 at decision block 303 that the start gradient solvent volume concentration value has been decreased less than 100 times, exemplary method 300 returns to step 301, wherein LC optimizer 11 decreases the start gradient solvent volume concentration value (e.g., by 10%) and recalculates retention volumes and resolution as described above using equations I or IV and III using the further decreased start gradient solvent volume concentration value. From step 301, exemplary method 300 continues as described above and below.

Returning to decision block 302, if a determination is made by LC optimizer 11 that a desired minimum resolution is attained (e.g., Rₛ>1.5 using equation III) during a theoretical run using the decreased start gradient solvent volume concentration value from step 301, the previously calculated end gradient solvent volume concentration value from step 202, and a predetermined gradient duration period (e.g., 10 column volumes), exemplary method 300 proceeds to step 304, wherein LC optimizer 11 provides optimized processing conditions (e.g., the decreased start gradient solvent volume concentration value from step 301, the previously calculated end gradient solvent volume concentration value from step 202, and a predetermined gradient duration period (e.g., 10 column volumes)) to the user and LC system component 12.

Returning to decision block 303, if a determination is made by LC optimizer 11 at decision block 303 that the start gradient solvent volume concentration value has been decreased 100 times, exemplary method 300 proceeds to step 305, wherein LC optimizer 11 (1) decreases the end gradient solvent volume concentration value (e.g., by 10%) and (2) recalculates retention volumes and resolution as described above using equations I or IV and III and the decreased start gradient solvent volume concentration value from step 301, the decreased end gradient solvent volume concentration value from step 305, and a predetermined gradient duration period (e.g., 10 column volumes).

From step 305, exemplary method 300 proceeds to decision block 306, wherein a determination is made by LC optimizer 11 whether (i) the two or more elutable components elute completely (i.e., V₁<Vₘ+Vₕ+V_{D}+V_{G} and V₂<Vₘ+Vₕ+V_{D}+V_{G} using equation I or IV above) and (ii) a desired minimum resolution (e.g., Rₛ>1.5 using equation III above) is attained during a theoretical run using the decreased start and end gradient solvent volume concentration values (i.e., φᵢₛ and φᵢₑ from steps 301 and 305) and a predetermined gradient period value (e.g., 10 column volumes).

If a determination is made by LC optimizer 11 at decision block 306 that a desired minimum resolution is not attained (e.g., Rₛ<1.5 using equation III) during a theoretical run using the decreased start gradient solvent volume concentration value from step 301, the decreased end gradient solvent volume concentration value from step 305, and a predetermined gradient duration period (e.g., 10 column volumes), exemplary method 300 proceeds to decision block 307.

At decision block 307, a determination is made by LC optimizer 11 whether the end gradient solvent volume concentration value has been decreased less than 100 times. If a determination is made by LC optimizer 11 at decision block 307 that the end gradient solvent volume concentration value has been decreased less than 100 times, exemplary method 300 returns to step 305, wherein LC optimizer 11 (1) further decreases the end gradient solvent volume concentration value (e.g., by 10%) and (2) recalculates retention volumes and resolution as described above using equations I or IV and III and the further decreased end gradient solvent volume concentration value. From step 305, exemplary method 300 continues as described above and below.

Returning to decision block 306, if a determination is made by LC optimizer 11 that a desired minimum resolution is attained (e.g., Rₛ>1.5 using equation III) during a theoretical run using the decreased start gradient solvent volume concentration value from step 301, the decreased end gradient solvent volume concentration value from step 305, and a predetermined gradient duration period (e.g., 10 column volumes), exemplary method 300 proceeds to step 308, wherein LC optimizer 11 provides optimized processing conditions (e.g., the decreased start gradient solvent volume concentration value from step 301, the decreased end gradient solvent volume concentration value from step 305, and a predetermined gradient duration period (e.g., 10 column volumes)) to the user and LC system component 12.

Returning to decision block 307, if a determination is made by LC optimizer 11 at decision block 307 that the end gradient solvent volume concentration value has been decreased 100 times, exemplary method 300 proceeds to step 308, wherein LC optimizer 11 provides optimized processing conditions (e.g., the decreased start gradient solvent volume concentration value from step 301, the decreased end gradient solvent volume concentration value from step 305, and a predetermined gradient duration period (e.g., 10 column volumes)) to the user and LC system component 12.

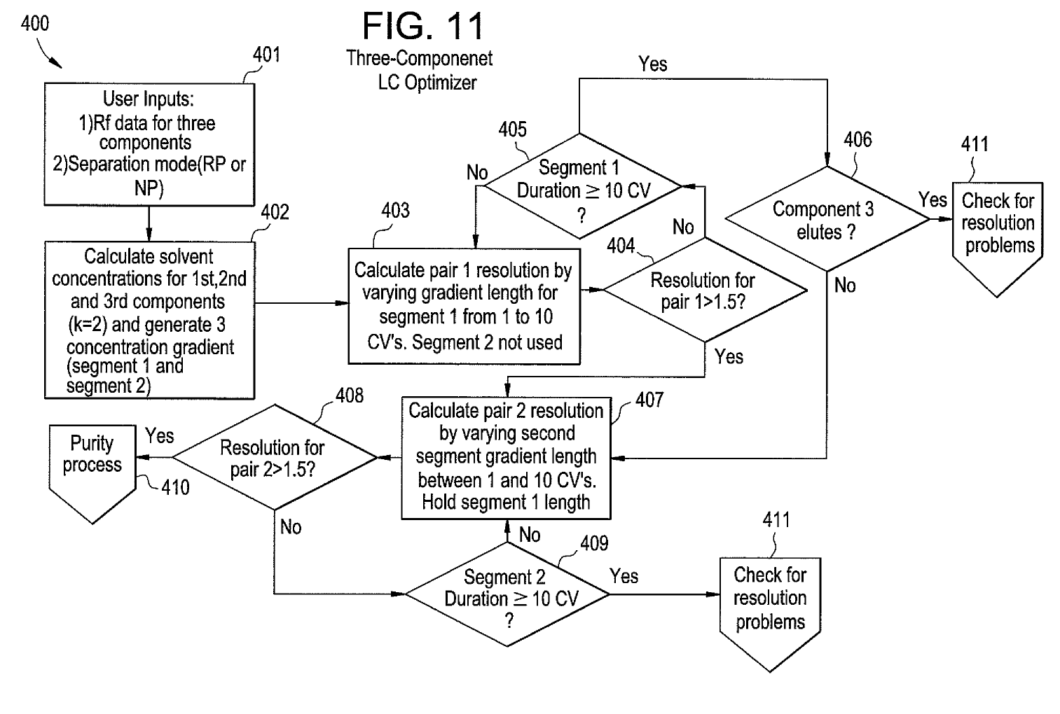

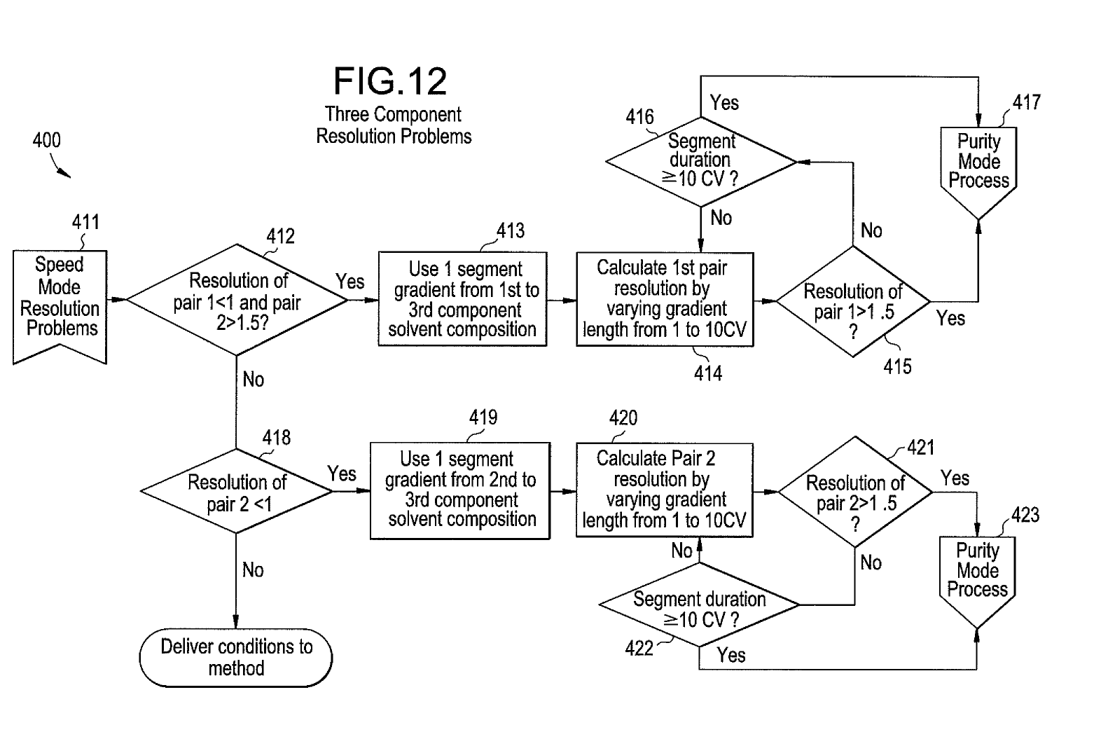

In the event that more than two components are to be separated in a sample, the LC optimizer of the present invention may be utilized to provide the user or computing system with the process conditions to perform the component separation. The operation or process remains the same as the two component separation, but more than two concentration gradients are generated to obtain separation of the additional component(s). For example, FIGS. 11 and 12 depict a method for the separation of three components. As shown in FIG. 11, exemplary method 400 starts at step 401, wherein a user inputs TLC data (e.g., retention factors R_{f} calculated by the user; first, second and third solvent composition and volume concentration values; and plate type), separation mode (i.e., normal or reverse phase) into LC optimizer 11. From step 401, exemplary method 400 proceeds to step 402, wherein initial start and end gradient solvent volume concentration values are calculated by LC optimizer 11 for segment 1 (components 1 and 2, referred to as pair 1) and for segment 2 (components 2 and 3, referred to as pair 2).

From step 402, exemplary method 400 proceeds to step 403, wherein retention volumes and resolution for pair 1 are calculated by LC optimizer 11 as described above for a given gradient period value of segment 1 (e.g., initially 1 column volume). From step 403, exemplary method 400 proceeds to decision block 404, wherein a determination is made by LC optimizer 11 whether (i) the first pair of elutable components of segment 1 elute completely and (ii) a desired minimum resolution (e.g., Rₛ>1.5) is attained during a theoretical run using the previously calculated initial start and end gradient solvent volume concentration values and an initial gradient duration period (i.e., one column volume).

If a determination is made by LC optimizer 11 at decision block 404 that a desired minimum resolution is not attained (e.g., Rₛ<1.5) during a theoretical run using the previously calculated initial start and end gradient solvent volume concentration values and the initial gradient duration period (i.e., one column volume), exemplary method 400 proceeds to decision block 405. At decision block 405, a determination is made by LC optimizer 11 whether the gradient duration period of segment 1 is greater than or equal to a predetermined gradient duration volume (e.g., 10 column volumes).

If a determination is made by LC optimizer 11 at decision block 405 that the gradient duration period is not greater than or equal to a predetermined gradient duration volume (e.g., 10 column volumes), exemplary method 400 returns to step 403, wherein LC optimizer 11 increases the gradient duration volume (e.g., by one column volume) and recalculates retention volumes and resolution for pair 1 as described above for the increased gradient period value of segment 1 (e.g., 2 to 10 column volumes). From step 403, exemplary method 400 continues as described above and below.

Returning to decision block 405, if a determination is made by LC optimizer 11 at decision block 405 that the gradient duration period is greater than or equal to a predetermined gradient duration volume (e.g., 10 column volumes), exemplary method 400 proceeds to decision block 406, wherein LC optimizer 11 determines whether component 3 elutes. If LC optimizer 11 determines that component 3 does not elute, exemplary method 400 proceeds to step 407 as discussed below. If LC 11 optimizer determines that component 3 does elute, exemplary method 400 proceeds to decision block 411, wherein LC optimizer 11 determines whether there are resolution problems as discussed below.

Returning to decision block 404, if a determination is made by LC optimizer 11 that a desired minimum resolution is attained for pair 1 (e.g., Rₛ>1.5) during a theoretical run using the previously calculated initial start and end gradient solvent volume concentration values and a given gradient duration period (i.e., 1 to 10 column volumes), exemplary method 400 proceeds to decision block 407 and proceeds as discussed above and below.

In step 407, optimizer 11 calculates retention volumes and resolution for pair 2 as described above for a given gradient period value of segment 2 (e.g., initially 1 column volume). From step 407, exemplary method 400 proceeds to decision block 408, wherein a determination is made by LC optimizer 11 whether (i) the pair 1 of elutable components of segment 1 elute completely and (ii) a desired minimum resolution (e.g., Rₛ>1.5) is attained during a theoretical run using the previously calculated initial start and end gradient solvent volume concentration values and an initial gradient duration period (i.e., one column volume).

If a determination is made by LC optimizer 11 at decision block 408 that a desired minimum resolution is not attained (e.g., Rₛ<1.5) during a theoretical run using the previously calculated initial start and end gradient solvent volume concentration values and the initial gradient duration period (i.e., one column volume), exemplary method 400 proceeds to decision block 409. At decision block 409, a determination is made by LC optimizer 11 whether the gradient duration period of segment 2 is greater than or equal to a predetermined gradient duration volume (e.g., 10 column volumes).

If a determination is made by LC optimizer 11 at decision block 409 that the gradient duration period is not greater than or equal to a predetermined gradient duration volume (e.g., 10 column volumes), exemplary method 400 returns to step 407, wherein LC optimizer 11 increases the gradient duration volume (e.g., by one column volume) and recalculates retention volumes and resolution for pair 2 as described above for the increased gradient period value of segment 2 (e.g., 2 to 10 column volumes). From step 407, exemplary method 400 continues as described above and below.

Returning to decision block 409, if a determination is made by LC optimizer 11 at decision block 409 that the gradient duration period is greater than or equal to a predetermined gradient duration volume (e.g., 10 column volumes), exemplary method 400 proceeds to decision block 411, wherein LC optimizer 11 determines whether there are resolution problems as discussed below.

Returning to decision block 408, if a determination is made by LC optimizer 11 that a desired minimum resolution is attained for pair 2 (e.g., Rₛ>1.5) during a theoretical run using the previously calculated initial start and end gradient solvent volume concentration values and a given gradient duration period of segment 2 (e.g., 1 to 10 column volumes), exemplary method 400 proceeds to decision block 410 and proceeds as discussed in the purity process 300 above and below.

FIG. 12 depicts a process for the solution of resolution problems, wherein the most problematic of the two pair of components is selected for further optimization using only one segment, and not two. From step 411 in FIG. 11, exemplary method 400 proceeds to step 412. In step 412, if a determination is made by LC optimizer 11 that a desired minimum resolution is attained for pair 2 (e.g., Rₛ>1.5) during a theoretical run using the previously calculated initial start and end gradient solvent volume concentration values and a given gradient duration period (i.e., 1 to 10 column volumes), and the desired minimum resolution is not attained for pair 1 (e.g., Rₛ<1.0), exemplary method 400 proceeds to decision block 413 where the LC optimizer selects one segment gradient from the first to the third component solvent composition.

From step 413, exemplary method 400 proceeds to step 414, wherein retention volumes and resolution for pair 1 are calculated by LC optimizer 11 as described above for a given gradient period value of (e.g., initially 1 column volume). From step 414, exemplary method 400 proceeds to decision block 415, wherein a determination is made by LC optimizer 11 whether (i) the first pair of elutable components elute completely and (ii) a desired minimum resolution (e.g., R_{S}>1.5) is attained during a theoretical run using the previously calculated initial start and end gradient solvent volume concentration values and an initial gradient duration period (i.e., one column volume).

If a determination is made by LC optimizer 11 at decision block 415 that a desired minimum resolution is not attained (e.g., Rₛ<1.5) during a theoretical run using the previously calculated initial start and end gradient solvent volume concentration values and the initial gradient duration period (i.e., one column volume), exemplary method 400 proceeds to decision block 416. At decision block 416, a determination is made by LC optimizer 11 whether the gradient duration period of is greater than or equal to a predetermined gradient duration volume (e.g., 10 column volumes).

If a determination is made by LC optimizer 11 at decision block 416 that the gradient duration period is not greater than or equal to a predetermined gradient duration volume (e.g., 10 column volumes), exemplary method 400 returns to step 414, wherein LC optimizer 11 increases the gradient duration volume (e.g., by one column volume) and recalculates retention volumes and resolution for pair 1 as described above for the increased gradient period value (e.g., 2 to 10 column volumes). From step 414, exemplary method 400 continues as described above and below.

Returning to decision block 416, if a determination is made by LC optimizer 11 at decision block 416 that the gradient duration period is greater than or equal to a predetermined gradient duration volume (e.g., 10 column volumes), exemplary method 400 proceeds to decision block 417 and to purity process 300.

Returning to decision block 415, if a determination is made by LC optimizer 11 that a desired minimum resolution is attained for pair 1 (e.g., Rₛ>1.5) during a theoretical run using the previously calculated initial start and end gradient solvent volume concentration values and a given gradient duration period (e.g., 1 to 10 column volumes), exemplary method 400 proceeds to decision block 417 and to purity process 300.

Returning to step 412, if a determination is made by LC optimizer 11 that a desired resolution is not attained for pair 2 (e.g., Rₛ>1.5) during a theoretical run using the previously calculated initial start and end gradient solvent volume concentration values and a given gradient duration period (e.g., 1 to 10 column volumes), or the resolution is at a minimum threshold value for pair 1 (e.g., Rₛ>1.0), exemplary method 400 proceeds to decision block 418 wherein the LC optimizer 11 determines whether the resolution is at a minimum threshold value for pair 2 (e.g., Rₛ<1.0). If a determination is made by LC optimizer 11 that a minimum threshold resolution is not attained for pair 2, exemplary method 400 proceeds to decision block 419 where the LC optimizer selects one segment gradient from the second to the third component solvent composition.

From step 419, exemplary method 400 proceeds to step 420, wherein retention volumes and resolution for pair 2 are calculated by LC optimizer 11 as described above for a given gradient period value (e.g., initially 1 column volume). From step 420, exemplary method 400 proceeds to decision block 421, wherein a determination is made by LC optimizer 11 whether (i) the first pair of elutable components of elute completely and (ii) a desired minimum resolution (e.g., Rₛ>1.5) is attained during a theoretical run using the previously calculated initial start and end gradient solvent volume concentration values and an initial gradient duration period (i.e., one column volume).

If a determination is made by LC optimizer 11 at decision block 421 that a desired minimum resolution is not attained (e.g., Rₛ<1.5) during a theoretical run using the previously calculated initial start and end gradient solvent volume concentration values and the initial gradient duration period (i.e., one column volume), exemplary method 400 proceeds to decision block 422. At decision block 422, a determination is made by LC optimizer 11 whether the gradient duration period is greater than or equal to a predetermined gradient duration volume (e.g., 10 column volumes).

If a determination is made by LC optimizer 11 at decision block 422 that the gradient duration period is not greater than or equal to a predetermined gradient duration volume (e.g., 10 column volumes), exemplary method 400 returns to step 420, wherein LC optimizer 11 increases the gradient duration volume (e.g., by one column volume) and recalculates retention volumes and resolution for pair 2 as described above for the increased gradient period value (e.g., 2 to 10 column volumes). From step 420, exemplary method 400 continues as described above and below.

Returning to decision block 422, if a determination is made by LC optimizer 11 at decision block 422 that the gradient duration period is greater than or equal to a predetermined gradient duration volume (e.g., 10 column volumes), exemplary method 400 proceeds to decision block 423 and to purity process 300.

Returning to decision block 421, if a determination is made by LC optimizer 11 that a desired minimum resolution is attained for pair 2 (e.g., Rₛ>1.5) during a theoretical run using the previously calculated initial start and end gradient solvent volume concentration values and a given gradient duration period (e.g., 1 to 10 column volumes), exemplary method 400 proceeds to decision block 423 and to purity process 300.

In any of the above-described exemplary methods, once a set of optimized gradient parameters has been provided to the user and LC system component 12, the user can simply accept, reject, or modify the set of optimized gradient parameters provided LC optimizer 11. LC optimizer 11 may further provide, for the user's review, one or more previously determined or inputted parameters including, but not limited to, a flow rate, an initial hold value, a final hold value, the column type, the column size, the sample composition, and the solvent composition.

Once the proper column is mounted in the unit, the proper solvents primed into the unit and the sample injection prepared, the automated chromatography run and fraction collection using LC system component 12 can be initiated using the set of optimized gradient parameters provided by LC optimizer 11 or a variation thereof.

In another exemplary embodiment, a method of determining one or more gradient parameter values for a liquid chromatography separation of elutable compounds may be performed by a computing system using software in a chromatography separation unit, wherein after a user inputs one or more properties of the elutable compounds into the computing system, the computing system provides the user with a recommended type of chromatography method, chromatography media, chromatography column size, and chromatography solvents to employ for separation of the elutable compounds.

In an even further exemplary embodiment, a method of separating two or more elutable compounds using liquid chromatography includes inputting one or more properties of the elutable compounds into a computing system in a chromatography separation unit, utilizing the computing system to generate gradient parameter values, automatically providing the gradient parameters to the chromatography separation unit or user, and separating the two or more elutable compounds.

In an exemplary embodiment, the gradient parameter values may be determined by utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one embodiment, the resolution may be recalculated by varying the start or end gradient solvent volume concentration values. In another exemplary embodiment, the resolution is recalculated by varying gradient solvent duration volume.

In another exemplary embodiment, the method includes initiating a gradient duration adjustment procedure if the resolution between each elutable compound is not achieved. The gradient duration adjustment may comprise (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating a start gradient solvent concentration adjustment procedure. The start gradient solvent concentration adjustment procedure may comprise (a) decreasing the start gradient solvent volume concentration to a decreased start gradient solvent volume concentration value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating an end gradient solvent concentration adjustment procedure. The end gradient solvent concentration adjustment procedure may comprise (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In one exemplary embodiment, a computing system using software in a chromatography separation unit, wherein after resolution calculation is complete, gradient parameter values (times and concentrations table) are automatically provided to the chromatography unit or user for separation of the compounds.

In an even further exemplary embodiment, a method of separating two or more elutable compounds using liquid chromatography includes inputting one or more properties of the elutable compounds into a computing system in a chromatography separation unit, utilizing the computing system to generate gradient parameters, automatically providing the gradient parameters to the chromatography separation unit or the user, utilizing the computing system to generate recommended type of chromatography method, chromatography media, chromatography column size, and chromatography solvents to employ for separation of the elutable compounds, and separating the two or more elutable compounds.

In an even further exemplary embodiment, a method of separating two or more elutable compounds using liquid chromatography includes inputting one or more properties of the elutable compounds into a computing system in a liquid chromatography system; utilizing the computing system to generate recommended type of chromatography method, chromatography media, chromatography column size, and chromatography solvents to employ for separation of the elutable compounds; and utilizing the computing system to generate gradient parameters values.

In another exemplary embodiment, the method of separating two or more elutable compounds using liquid chromatography further may include automatically providing the gradient parameters to the liquid chromatography system or a user; and separating the two or more elutable compounds.

In an exemplary embodiment, the method may further include imputing chromatography retention data of the two or more eluatable compounds prior to the step of utilizing the computing system to generate gradient parameters.

In an exemplary embodiment, the gradient parameter values may be determined by utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one embodiment, the resolution may be recalculated by varying the start or end gradient solvent volume concentration values. In another exemplary embodiment, the resolution is recalculated by varying gradient solvent duration volume.

In another exemplary embodiment, the method includes initiating a gradient duration adjustment procedure if the resolution between each elutable compound is not achieved. The gradient duration adjustment may comprise (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating a start gradient solvent concentration adjustment procedure. The start gradient solvent concentration adjustment procedure may comprise (a) decreasing the start gradient solvent volume concentration to a decreased start gradient solvent volume concentration value; (b) recalculating retention volumes for each elutable compound; (c) determining whether resolution between each elutable compound is achieved; and (d) repeating steps (a), (b) and (c) if resolution is not achieved.

In another exemplary embodiment, the method further includes initiating an end gradient solvent concentration adjustment procedure. The end gradient solvent concentration adjustment procedure may comprise (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In one exemplary embodiment, a computing system using software in a chromatography separation unit, wherein after resolution calculation is complete, gradient parameter values (times and concentrations table) are automatically provided to the chromatography unit or user for separation of the compounds.

In another exemplary embodiment, a method of separating two or more elutable compounds using liquid chromatography includes inputting chromatography retention data of the elutable compounds into a computing system in a liquid chromatography apparatus; utilizing the computing system to estimate capacity factors of the two or more elutable compounds; utilizing the computing system to determine whether the two or more elutable compounds will not separate with the estimated capacity factors; utilizing the computing system to generate at least one recommended type of chromatography method, chromatography media, chromatography column size, and chromatography solvents to employ for separation of the elutable compounds; and utilizing the at least one recommended type of chromatography method, chromatography media, chromatography column size, and chromatography solvents to separate the two or more elutable compounds.

### II. Liquid Chromatography (LC) Systems and LC Optimization Software

The present invention is further directed to liquid chromatography (LC) systems and LC optimization software capable of providing one or more separation parameter values to a user for use in a liquid chromatography separation unit.

In one exemplary embodiment, the liquid chromatography system comprises a computing system, and a user interface with the computing system, wherein the computing system is capable of utilizing chromatography retention data to estimate capacity factors, k's, of two or more elutable compounds within (i) a first separation comprising a first solvent volume concentration and (ii) a second separation comprising a second solvent volume concentration, wherein the second solvent volume concentration is different than the first solvent volume concentration; utilizing the estimated capacity factors in combination with an optimum capacity factor value, kₒₚₜ, to determine (i) a start gradient solvent volume concentration value, and (ii) an end gradient solvent volume concentration value for the liquid chromatography separation; and providing (i) the start gradient solvent volume concentration value, and (ii) the end gradient solvent volume concentration value to the user for review.

The present invention is even further directed to liquid chromatography systems comprising a computing system, and a user interface with the computing system, wherein the computing system is capable of utilizing chromatography retention data to estimate capacity factors, k's, of at least two elutable compounds at two different solvent volume concentrations; and utilizing the estimated capacity factors in combination with an optimum capacity factor value, kₒₚₜ, to determine an optimized gradient duration period, an optimized start gradient solvent volume concentration, an optimized end gradient solvent volume concentration, or any combination thereof.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In some exemplary embodiments, the liquid chromatography system is capable of providing one or more separation parameter values to a user for a liquid chromatography separation, and comprises a computing system, and a user interface with the computing system, wherein the computing system is capable of utilizing retention data to estimate capacity factors, k's, of two or more elutable compounds; utilizing the estimated capacity factors in combination with an optimum capacity factor value, kₒₚₜ, to determine (i) a start gradient solvent volume concentration value, and (ii) an end gradient solvent volume concentration value for the liquid chromatography separation; and providing (i) the start gradient solvent volume concentration value, and (ii) the end gradient solvent volume concentration value to the user for review.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In an exemplary embodiment, a liquid chromatography system includes a computing system; and a user interface with the computing system; wherein the computing system is capable of utilizing chromatography retention data to estimate capacity factors of two or more elutable compounds; and utilizing the estimated capacity factors in combination with an optimum capacity factor value to determine (i) a start gradient solvent volume concentration value, and (ii) an end gradient solvent volume concentration value for the liquid chromatography separation.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In one exemplary embodiment, the chromatography retention data is obtained using thin layer chromatography.

In another exemplary embodiment, the computing system is capable of utilizing the chromatography retention data to estimate capacity factors of the two or more elutable compounds comprising (i) a first separation comprising a first solvent volume concentration and (ii) a second separation comprising a second solvent volume concentration, wherein the second solvent volume concentration is different than the first solvent volume concentration.

In another exemplary embodiment, the computing system is capable of utilizing the start and end gradient solvent volume concentration values to calculate retention volumes of each elutable compound.

In a further exemplary embodiment, the computing system is capable of utilizing the retention volumes of each elutable compound to calculate resolution between each elutable compound.

In an even further exemplary embodiment, the computing system is capable of initiating a gradient duration adjustment procedure if the resolution between each elutable compound is not achieved.

In an exemplary embodiment, the computing system performs the gradient duration adjustment procedure by (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the computing system is capable of initiating a start gradient solvent concentration adjustment procedure.

In an exemplary embodiment, the computing system performs the start gradient solvent adjustment procedure by (a) decreasing the start gradient solvent volume concentration to a decreased start gradient solvent volume concentration value (b) recalculating retention volumes for each elutable compound; (c) determining whether resolution between each elutable compound is achieved; and (d) repeating steps (a), (b) and (c) if resolution is not achieved.

In a further exemplary embodiment, the computing system is capable of initiating an end gradient solvent concentration adjustment procedure. In an exemplary embodiment, the computing system performs the end gradient solvent concentration adjustment procedure by (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In an exemplary embodiment, a liquid chromatography system includes a computing system, and a user interface with the computing system, wherein the computing system is capable of utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the retention volumes of each elutable compound.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In a further exemplary embodiment, the computing system is capable of utilizing the retention volumes of each elutable compound to calculate resolution between each elutable compound.

In an even further exemplary embodiment, the computing system is capable of initiating a gradient duration adjustment procedure if the resolution between each elutable compound is not achieved.

In an exemplary embodiment, the computing system performs the gradient duration adjustment procedure by (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the computing system is capable of initiating a start gradient solvent concentration adjustment procedure.

In an exemplary embodiment, the computing system performs the start gradient solvent adjustment procedure by (a) decreasing the start gradient solvent volume concentration to a decreased start gradient solvent volume concentration value (b) recalculating retention volumes for each elutable compound; (c) determining whether resolution between each elutable compound is achieved; and (d) repeating steps (a), (b) and (c) if resolution is not achieved.

In a further exemplary embodiment, the computing system is capable of initiating an end gradient solvent concentration adjustment procedure.

In an exemplary embodiment, the computing system performs the end gradient solvent concentration adjustment procedure by (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b) and (c) if resolution is not achieved.

In a further exemplary embodiment, a liquid chromatography system comprises a computing system, and a user interface with the computing system, wherein the computing system is capable of utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one embodiment, the computing system is capable of utilizing the chromatography retention data to estimate capacity factors of the two or more elutable compounds using (i) a first separation comprising a first solvent volume concentration and (ii) a second separation comprising a second solvent volume concentration, wherein the second solvent volume concentration is different than the first solvent volume concentration.

In one embodiment, the resolution may be recalculated by varying the start or end gradient solvent volume concentration values.

In another exemplary embodiment, the resolution is recalculated by varying gradient solvent duration volume.

In one exemplary embodiment, a computing system using software in a chromatography separation unit, wherein after resolution calculation is complete, gradient parameter values (times and concentrations table) are automatically provided to the chromatography unit or user for separation of the compounds.

In an even further exemplary embodiment, the computing system is capable of initiating a gradient duration adjustment procedure if the resolution between each elutable compound is not achieved.

In an exemplary embodiment, the computing system performs the gradient duration adjustment procedure by (a) increasing an initial gradient duration period value to an increased gradient duration period value; (b) recalculating retention volumes for each elutable compound; (c) determining whether resolution between each elutable compound is achieved; and (d) repeating steps (a), (b) and (c) if resolution is not achieved.

In another exemplary embodiment, the computing system is capable of initiating a start gradient solvent concentration adjustment procedure.

In an exemplary embodiment, the computing system performs the start gradient solvent adjustment procedure by (a) decreasing the start gradient solvent volume concentration to a decreased start gradient solvent volume concentration value (b) recalculating retention volumes for each elutable compound; (c) determining whether resolution between each elutable compound is achieved; and (d) repeating steps (a), (b) and (c) if resolution is not achieved.

In a further exemplary embodiment, the computing system is capable of initiating an end gradient solvent concentration adjustment procedure.

In an exemplary embodiment, the computing system performs the end gradient solvent concentration adjustment procedure by (a) decreasing the end gradient solvent volume concentration to a decreased end gradient solvent volume concentration value; (b) recalculating retention volumes for each elutable compound; (c) determining whether resolution between each elutable compound is achieved; and (d) repeating steps (a), (b), and (c) if resolution is not achieved.

In one exemplary embodiment, the computing system, after the resolution calculation is complete, automatically provides gradient parameter values are to the liquid chromatography system or a user for separation of the compounds.

In another exemplary embodiment, the computing system, after a user inputs the elutable compound properties into the computing system, provides the user with at least one recommended type of chromatography method, chromatography media, chromatography column size, and chromatography solvents to employ for separation of the elutable compounds.

The computing system may be any computer or microprocessor that is capable of performing the disclosed methods of the present invention. Suitable computing systems include, but are not limited to, a personal computer, a mainframe computer, a microprocessor, etc.

The liquid chromatography system comprises one or more user interface components. Suitable user interface components include, but are not limited to, a keyboard for entering data (e.g., chromatography retention data 13) into the liquid chromatography system, a visual display for providing results (e.g., suggested liquid chromatography system parameters 14) to a user, or any combination thereof.

The liquid chromatography systems of the present invention are desirably capable of utilizing thin layer chromatography plate data for a sample comprising two or more elutable compounds to calculate capacity factors, k, for each of the two or more elutable compounds using two solvent mixture systems, wherein k=(1−R_{f})/R_{f}, and R_{f} represents a retention factor for a given compound in a given solvent mixture system; determining parameters (i) k₀ and m or (ii) a and m in at least one equation selected from k=k₀φ^{-m} for a normal phase system and ln k=a−mφ for a reverse phase system using the calculated capacity factors and first and second gradient solvent volume concentrations of the first and second solvent mixture systems; and calculating initial start and end gradient solvent volume concentration values, φᵢₛ and φᵢₑ respectively, using an optimum capacity factor value, kₒₚₜ and parameters (i) k₀ and m or (ii) a and m in at least one equation selected from φ=[(k₀/kₒₚₜ)^{1/m}] for a normal phase system, and φ=[(a−ln kₒₚₜ)/m] for a reverse phase system. As discussed above, the optimum capacity factor value, kₒₚₜ, may be equal to 2.0 in some embodiments.

In exemplary embodiments of the present invention, the liquid chromatography system comprises a computing system that is further capable of initiating (i) a gradient duration period adjustment procedure (e.g., as shown in FIG. 6), (ii) a start gradient solvent volume concentration adjustment procedure (e.g., as shown in FIG. 7), (iii) an end gradient solvent volume concentration adjustment procedure (e.g., as shown in FIG. 8), or (iv) any combination of (i) to (iii) as needed to provide one or more optimized separation parameter values to a user.

In some embodiments, the liquid chromatography systems of the present invention comprises software or code that enables the system to utilize the capacity factors, k's, and the first and second solvent volume concentrations to determine parameters (i) k₀ and m or (ii) a and m of at least one equation selected from k=k₀φ^{-m} for a normal phase system, and ln k=a−mφ for a reverse phase system; calculate initial start and end gradient solvent volume concentration values, φᵢₛ and φᵢₑ respectively, using an optimum capacity factor value, kₒₚₜ and parameters (i) k₀ and m or (ii) a and m in at least one equation selected from φ=[(k₀/kₒₚₜ)^{1/m}] for a normal phase system, and φ=[(a−ln kₒₚₜ)/m] for a reverse phase system; utilize the initial start and end gradient solvent volume concentration values, and a gradient duration period value to calculate (i) retention volumes for each elutable compound using at least one of equations I (for a normal phase mode) or IV (for a reverse phase mode) wherein A=the start gradient volume concentration value; B=[(the end gradient volume concentration value)−(the start gradient volume concentration value)]/(the gradient duration period value); Vₘ is a column void volume; V_{D} is a dwell volume; and Vₕ is an initial hold volume, (ii) an average bandwidth of peaks of each elutable compound, w_{g}, using equation II wherein V₁ and V₂ are V_{R} values for elutable compounds 1 and 2 using equation I or IV above, and N is a column efficiency, and (iii) a resolution between component peaks using equation M.

If (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, the system provides the initial start and end gradient solvent volume concentration values, and the initial gradient duration value, t_{g}, to a user for review. If (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, the system either (i) provides the initial start and end gradient solvent volume concentration values, and the initial gradient duration value, t_{g}, to a user for review, or (ii) initiates a gradient duration period adjustment procedure.

In some embodiments, the liquid chromatography systems of the present invention comprise software or code that also enables the system to initiate a gradient duration period adjustment procedure. The gradient duration period adjustment procedure may comprise (a) increasing the initial gradient duration period value to an increased gradient duration period value; (b) recalculating (i) retention volumes for each elutable compound using at least one of equations I and IV and the increased gradient duration period value, (ii) the average bandwidth of peaks, w_{g}, using equation II, and (iii) the resolution using equation III; and (c) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained. If (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, the system provides the initial start and end gradient solvent volume concentration values, and the increased gradient duration value to the user for review.

If (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, the system repeats steps (a), (b), and (c), wherein steps (a), (b) and (c) are repeated up to a first fixed number of times. If the first fixed number of times is reached, the system either (i) provides the initial start and end gradient solvent volume concentration values, and the increased gradient duration value to the user for review, or (ii) initiates a start gradient solvent volume concentration adjustment procedure.

In some embodiments, the liquid chromatography systems of the present invention comprise software or code that further enables the system to initiate a start gradient solvent volume concentration adjustment procedure. The start gradient solvent volume concentration adjustment procedure may comprise (e) decreasing the start gradient solvent volume concentration to a decreased start gradient solvent volume concentration value; (f) recalculating (i) retention volumes for each elutable compound using at least one of equations I and IV, the increased gradient duration period value, the decreased start gradient solvent volume concentration value, and the initial end gradient solvent volume concentration value, (ii) the average bandwidth of peaks, w_{g}, using equation II, and (iii) the resolution using equation III; and (g) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained.

If (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, the system provides the decreased start gradient solvent volume concentration value, the initial end gradient solvent volume concentration value, and the increased gradient duration value to the user for review. If (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, the system repeats steps (e), (f) and (g), wherein steps (e), (f) and (g) are repeated up to a second fixed number of times. If the second fixed number of times is reached, the system either (i) provides the decreased start gradient solvent volume concentration value, the initial end gradient solvent volume concentration value, and the increased gradient duration value to the user for review, or (ii) initiates an end gradient solvent volume concentration adjustment procedure.

In some embodiments, the liquid chromatography systems of the present invention comprise software or code that also enables the system to initiate an end gradient solvent volume concentration adjustment procedure. The end gradient solvent volume concentration adjustment procedure may comprise (p) decreasing the end gradient solvent volume concentration to a decreased end gradient solvent volume concentration value; (q) recalculating (i) retention volumes for each elutable compound using at least one of equations I and IV, the increased gradient duration period value, the decreased start gradient solvent volume concentration value, and the decreased end gradient solvent volume concentration value, (ii) the average bandwidth of peaks, w_{g}, using equation II, and (iii) the resolution using equation and (r) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained.

If (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, the system provides the decreased start gradient solvent volume concentration value, the decreased end gradient solvent volume concentration value, and the increased gradient duration value to the user for review. If (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, the system repeats steps (p), (q) and (r), wherein steps (p), (q) and (r) are repeated up to a third fixed number of times. If the third fixed number of times is reached, the system provides the decreased start gradient solvent volume concentration value, the decreased end gradient solvent volume concentration value, and the increased gradient duration value to the user for review.

In any of the above-described liquid chromatography systems, the computing system is further capable of providing (i) an initial or decreased start solvent volume concentration value, (ii) an initial or decreased end gradient solvent volume concentration value, and (iii) the increased gradient duration value to a liquid chromatography separation unit for use in liquid chromatography separation unit software, wherein the liquid chromatography separation unit software is operatively adapted to accept and utilize (i) the initial or decreased start solvent volume concentration value, (ii) the initial or decreased end gradient solvent volume concentration value, and (iii) the increased gradient duration value during a liquid chromatography separation procedure. A user simply accepts, modifies, or rejects the optimized process parameters as presented by the liquid chromatography system to initiate a liquid chromatography separation run using the optimized process parameters as presented by the liquid chromatography system or a variation thereof.

In another exemplary embodiment, a liquid chromatography system is capable of separating two or more elutable compounds with liquid chromatography using one or more properties of the elutable compounds input into a computing system in communication with the liquid chromatography system, capable of determining one or more gradient parameter values for a liquid chromatography separation of the elutable compounds performed by the computing system, and capable of providing the user with a recommended type of chromatography method, chromatography media, chromatography column size, and chromatography solvents to employ for separation of the elutable compounds after a user inputs one or more properties of the elutable compounds into the computing system.

In a further exemplary embodiment, a liquid chromatography system is capable of separating two or more elutable compounds with liquid chromatography using one or more properties of the elutable compounds input into a computing system in communication with the liquid chromatography system, capable of determining one or more gradient parameter values for a liquid chromatography separation of the elutable compounds performed by the computing system, and capable of automatically providing the gradient parameters to the chromatography system.

In an exemplary embodiment, a liquid chromatography system includes a computing system; and a user interface with the computing system; wherein the liquid chromatography system is capable of (a) separating two or more elutable compounds with liquid chromatography using one or more properties of the elutable compounds input into a computing system, which is in communication with the liquid chromatography system; (b) determining one or more gradient parameter values for a liquid chromatography separation of the elutable compounds performed by the computing system; and (c) automatically providing the gradient parameters to the chromatography system or a user.

In an exemplary embodiment, the computing system is capable of determining the gradient parameter values by utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one embodiment, the resolution may be recalculated by varying the start or end gradient solvent volume concentration values as described herein.

In another exemplary embodiment, the resolution is recalculated by varying gradient solvent duration volume as described herein.

In one exemplary embodiment, a computing system using software in a chromatography separation unit, wherein after resolution calculation is complete, gradient parameter values (times and concentrations table) are automatically provided to the chromatography unit or user for separation of the compounds.

In an even further exemplary embodiment, a liquid chromatography system is capable of separating two or more elutable compounds with liquid chromatography using one or more properties of the elutable compounds input into a computing system in communication with the liquid chromatography system, capable of determining one or more gradient parameter values for a liquid chromatography separation of the elutable compounds performed by the computing system, capable of automatically providing the gradient parameters to the chromatography system, and capable of utilizing the computing system to generate recommended type of chromatography method, chromatography media, chromatography column size, and chromatography solvents to employ for separation of the elutable compounds.

In an exemplary embodiment, a liquid chromatography system includes a computing system; and a user interface with the computing system; wherein the liquid chromatography system is capable of (a) separating two or more elutable compounds with liquid chromatography using one or more properties of the elutable compounds input into a computing system, which is in communication with the liquid chromatography system; (b) utilizing the computing system to generate at least one recommended type of chromatography method, chromatography media, chromatography column size, and chromatography solvents to employ for separation of the elutable compounds; and (c) utilizing the computing system to determine one or more gradient parameter values for a liquid chromatography separation of the elutable compounds.

In one exemplary embodiment, the computing system is capable of automatically providing the gradient parameters to the liquid chromatography system or a user; and communicating with the liquid chromatography system to separate the two or more elutable compounds.

In an exemplary embodiment, the computing system is capable of determining the gradient parameter values by utilizing chromatography retention data to estimate capacity factors of two or more elutable compounds; utilizing the estimated capacity factors in combination with an optimum capacity factor value to determine (i) a start gradient solvent volume concentration value, and (ii) an end gradient solvent volume concentration value for the liquid chromatography separation; and utilizing the start and end gradient solvent volume concentration values to calculate the elutable compound retention volumes and resolution between the elutable compounds.

In one embodiment, the resolution may be recalculated by varying the start or end gradient solvent volume concentration values as described herein.

In another exemplary embodiment, the resolution is recalculated by varying gradient solvent duration volume as described herein.

In one exemplary embodiment, a computing system using software in a chromatography separation unit, wherein after resolution calculation is complete, gradient parameter values (times and concentrations table) are automatically provided to the chromatography unit or user for separation of the compounds.

In an exemplary embodiment, a liquid chromatography system includes a computing system; and a user interface with the computing system; wherein the liquid chromatography system is capable of (a) separating two or more elutable compounds with liquid chromatography using one or more properties of the elutable compounds input into a computing system, which is in communication with the liquid chromatography system; (b) determining one or more gradient parameter values for a liquid chromatography separation of the elutable compounds performed by the computing system; and (c) providing the user with a recommended type of chromatography method, chromatography media, chromatography column size, and chromatography solvents to employ for separation of the elutable compounds after the user inputs one or more properties of the elutable compounds into the computing system.

In an exemplary embodiment, a liquid chromatography system includes a computing system; and a user interface with the computing system; wherein the liquid chromatography system is capable of (a) utilizing the computing system to estimate capacity factors of the two or more elutable compounds using retention data of the elutable compounds into a computing system; (b) utilizing the computing system to determine whether the two or more elutable compounds will not separate with the estimated capacity factors; (c) utilizing the computing system to generate at least one recommended type of chromatography method, chromatography media, chromatography column size, and chromatography solvents to employ for separation of the elutable compounds; and (d) utilizing the at least one recommended type of chromatography method, chromatography media, chromatography column size, and chromatography solvents to separate the two or more elutable compounds.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Normal Phase Separation of Two Components (Speed Mode)

The user selected silica as the TLC plate type (normal phase), spotted the two components (butyl paraben and methyl paraben) on a plate and ran with a 20% solvent volume concentration. The R_{f} values of the two components were 0.35 and 0.24. The user potted another plate and ran this one with 30% solvent volume concentration. The R_{f} values of the two components were 0.50 and 0.39. The user selected a 12 g silica column (normal phase) and a flow rate of 36 mL/min for the LC separation. The user inputs the data into the LC optimizer, which has been installed in a flash chromatography system (i.e., REVELERIS™ flash system available from Grace Davison Discovery Sciences) and selects the speed mode.

The optimizer calculates m=1.53 and k₀=0.16 for the first peak and m=1.74 and k₀=0.19 for the second peak as parameters for the equation k=k₀φ^{-m}. Using kₒₚₜ=2 as k in this equation and the parameters for the first peak gives a start gradient volume concentration of 19%. Using the parameters of the second peak results in an end gradient volume concentration of 27%.

By setting the gradient volume at one column volume and iteratively increasing it, ending (in this case) with maximum gradient volume of ten column volumes, both components elute from column. The LC optimizer, based on the speed mode, provides the gradient profile, as set forth in Table 1 below, as output to user for review.

TABLE 1

| Time | Gradient Volume |
|---|---|
| (minutes) | Concentration |
| 0.0 | 19% |
| 0.7 | 19% |
| 4.7 | 27% |
| 3.8 | 27% |

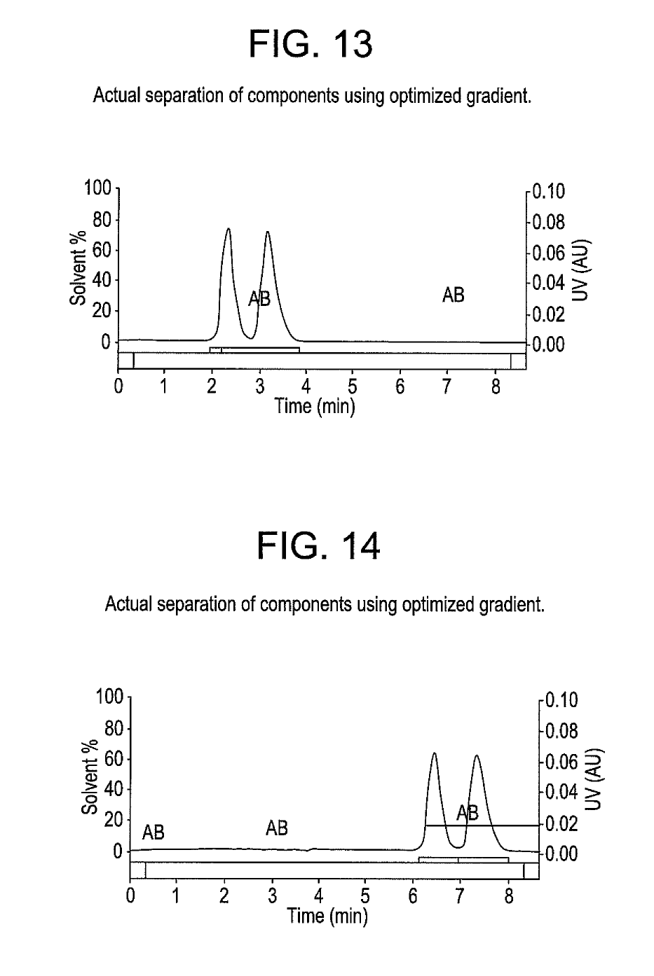

The gradient profile was also provided as input to a liquid chromatography system component (e.g., liquid chromatography system component 12). The user accepted the data, and initiated a liquid chromatography separation procedure. FIG. 13 graphically depicts the actual chromatogram showing separation of the two elutable components using the optimized gradient procedure described above in Example 1.

### Example 2

### Normal Phase Separation of Two Components (Purity Mode)

The user selected silica as the TLC plate type, spotted the two components (butyl paraben and methyl paraben) on a plate and ran with a 20% solvent volume concentration. The R_{f} values of the two components were 0.35 and 0.24. The user then spotted another plate and ran this one with 30% solvent volume concentration. The R_{f} values of the two components were 0.50 and 0.39. The user selected a 12 g silica column and a flow rate of 36 mL/min for the LC separation. The user inputs the data into the LC optimizer, which has been installed in a REVELERIS™ flash system and selects the purity mode.

The optimizer calculates m=1.53 and k₀=0.16 for the first peak and m=1.74 and k₀=0.19 for the second peak as parameters for the equation k=k₀φ^{-m}. Using kₒₚₜ=2 as k in this equation and the parameters for the first peak gives a start gradient volume concentration of 19%. Using the parameters of the second peak results in an end gradient volume concentration of 27%.

By setting the gradient volume at one column volume and iteratively increasing it, ends (in this case) with maximum gradient volume of ten column volumes, both components elute from column. Since good resolution is not obtained, based on the purity mode, the LC optimizer proceeds to the optimization of the start gradient volume concentration.

The start gradient volume concentration is iteratively decreased all the way to 0% without obtaining good resolution even though both components elute from column. The LC optimizer proceeds to the optimization of the end gradient volume concentration.

The end gradient volume concentration is iteratively decreased to 19% and both components elute from column. The optimum resolution for this run time has been obtained. The gradient profile, as set forth in Table 2 below, is now provided as output to the user.

TABLE 2

| Time | Gradient Volume |
|---|---|
| (minutes) | Concentration |
| 0.0 | 0% |
| 1.0 | 0% |
| 4.7 | 19% |
| 3.8 | 19% |

The gradient profile was also provided as input to a liquid chromatography system component (e.g., liquid chromatography system component 12). The user accepted the data, and initiated a liquid chromatography separation procedure. FIG. 14 graphically depicts the actual chromatogram showing separation of the two elutable components using the optimized gradient procedure described above in Example 2.

### Example 3

### Normal Phase Separation of Two Components (Speed Mode)

The user selected silica as the TLC plate type, spotted the two components (dioctyl phthalate and butyl paraben) on a plate and ran with a 20% solvent volume concentration. The R_{f} values of the two components were 0.75 and 0.35. The user then spotted another plate and ran this one with 30% solvent volume concentration. The R_{f} values of the two components were 0.80 and 0.50. The user selected a 12 g silica column and a flow rate of 36 mL/min for the LC separation. The user inputs the data into the LC optimizer, which has been installed in a REVELERIS™ flash system and selects the speed mode.

The optimizer calculates m=0.71 and k₀=0.11 for the first peak and m=1.53 and k₀=0.16 for the second peak as parameters for the equation k=k₀ ^{-m}. Using kₒₚₜ=2 as k in this equation and the parameters for the first peak gives a start gradient volume concentration of 2%. Using the parameters of the second peak results an end gradient volume concentration of 20%.

By setting the gradient volume at one column volume and iteratively increasing it, ending (in this case) with a maximum gradient volume of five column volumes, both components elute from column, Good resolution is obtained. The LC optimizer, based on the speed mode, provides the gradient profile, as set forth in Table 3 below, as output to user for review.

TABLE 3

| Time | Gradient Volume |
|---|---|
| (minutes) | Concentration |
| 0.0 | 2% |
| 0.6 | 2% |
| 2.4 | 20% |
| 2.5 | 20% |

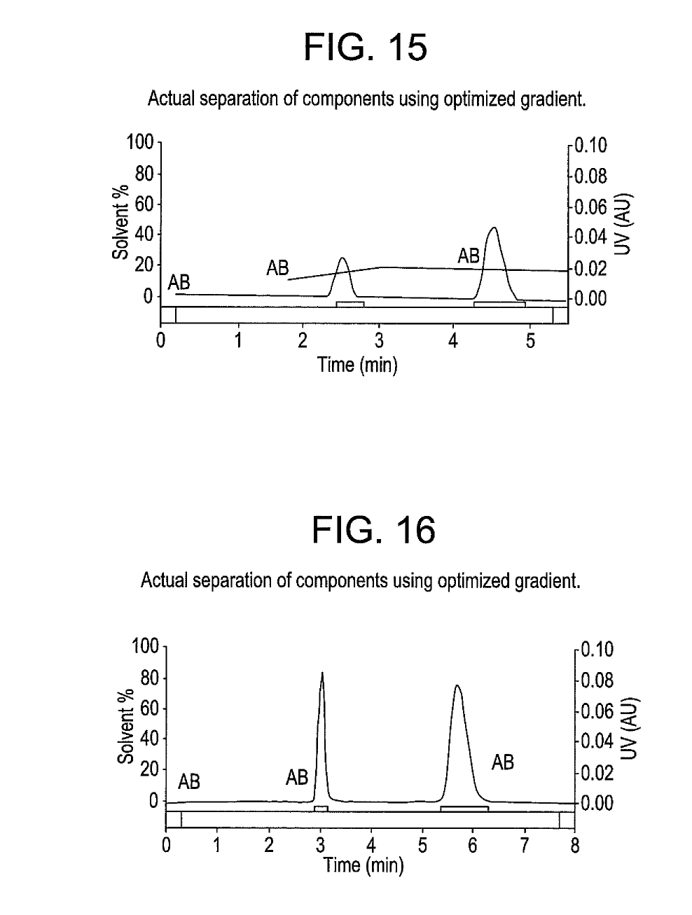

The gradient profile was also provided as input to a liquid chromatography system component (e.g., liquid chromatography system component 12). The user accepted the data, and initiated a liquid chromatography separation procedure. FIG. 15 graphically depicts the actual chromatogram showing separation of the two elutable components using the optimized gradient procedure described above in Example 3.

### Example 4

### Normal Phase Separation of Two Components (Purity Mode)

The user selected silica as the TLC plate type, spotted the two components (dioctyl phthalate and butyl paraben) on a plate and ran with a 20% solvent volume concentration. The R_{f} values of the two components (dioctyl phthalate and butyl paraben) were 0.75 and 0.35. The user then spotted another plate and ran this one with 30% solvent volume concentration. The R_{f} values of the two components were 0.80 and 0.50. The user selected a 12 g silica column and a flow rate of 36 mL/min for the LC separation. The user inputs the data into the LC optimizer, which has been installed in a REVELERIS™ flash system and selects the purity mode.

The optimizer calculates m=0.71 and k₀=0.11 for the first peak and m=1.53 and k₀=0.16 for the second peak as parameters for the equation k=k₀φ^{-m}. Using kₒₚₜ=2 as k in this equation and the parameters for the first peak provides a start gradient volume concentration of 2%. Using the parameters of the second peak provides an end gradient volume concentration of 20%.

By setting the gradient volume at one column volume and iteratively increasing it, ending (in this case) with maximum gradient volume of ten column volumes based on the purity mode setting, both components elute from column. Because of the rigorous conditions set in the purity mode, better resolution is obtained than in speed mode. The LC optimizer provides the gradient profile, as set forth in Table 4 below, as output to user for review.

TABLE 4

| Time | Gradient Volume |
|---|---|
| (minutes) | Concentration |
| 0.0 | 2% |
| 0.6 | 2% |
| 4.7 | 20% |
| 2.7 | 20% |

The gradient profile was also provided as input to a liquid chromatography system component (e.g., liquid chromatography system component 12). The user accepted the data, and initiated a liquid chromatography separation procedure. FIG. 16 graphically depicts the actual chromatogram showing separation of the two elutable components using the optimized gradient procedure described above in Example 4.

### Example 5

### Normal Phase Separation of Three Components

The user selected silica as the TLC plate type, spotted the three components (α-Tocopherol, δ-tocopherol, and methyl paraben) on a plate and ran with a 20% solvent volume concentration. The R_{f} values of the three components were 0.69, 0.57 and 0.24. The user then spotted another plate and ran this one with 30% solvent volume concentration. The R_{f} values of the three components were 0.75, 0.68 and 0.39. The user selected a 12 g silica column and a flow rate of 36 mL/min for the LC separation. The user inputs the data into the LC optimizer, which has been installed in a REVELERIS™ flash system.

The optimizer calculates m=0.74 and k₀=0.14 for the first peak, m=1.16 and k₀=0.12 for the second peak and m=1.74 and k₀=0.19 for the third peak as parameters for the equation k=k₀φ^{-m}. Using kₒₚₜ=2 as k in this equation and the parameters for the first peak gives a start gradient volume concentration of 3%. Using the parameters of the second peak gives an end gradient volume concentration for the first segment of 9%. Using the parameters of the third peak gives an end gradient volume concentration for the second segment of 27%.

By setting the gradient volume of the first segment at one column volume and iteratively increasing it, ending with a gradient volume of 3 column volumes, good resolution is obtained. The first and second peaks elute but the third does not. Consequently, the use of a second segment is needed to achieve resolution of the components. By setting the gradient volume of the second segment at one column volume and iteratively increasing it, ending with a gradient volume of 4 column volumes, good resolution is obtained. The LC optimizer provides the gradient profile, as set forth in Table 5 below, as output to user for review.

TABLE 5

| Time | Gradient Volume |
|---|---|
| (minutes) | Concentration |
| 0.0 | 3% |
| 0.6 | 3% |
| 1.4 | 9% |
| 1.9 | 27% |
| 2.5 | 27% |

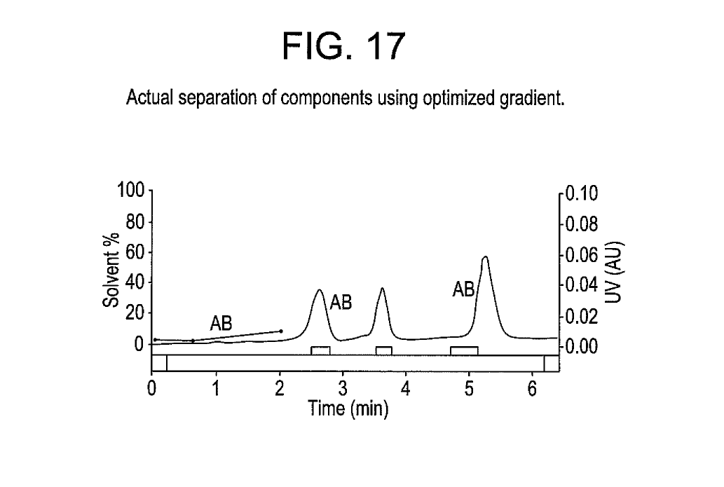

The gradient profile was also provided as input to a liquid chromatography system component (e.g., liquid chromatography system component 12). The user accepted the data, and initiated a liquid chromatography separation procedure. FIG. 17 graphically depicts the actual chromatogram showing separation of the three elutable components using the optimized gradient procedure described above in Example 5.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed.

Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A method of determining one or more gradient parameter values for a liquid chromatography separation, said method comprising:
utilizing chromatography retention data to estimate capacity factors, k's, of two or more elutable compounds within (i) a first separation comprising a first solvent volume concentration and (ii) a second separation comprising a second solvent volume concentration, wherein the second solvent volume concentration is different than the first solvent volume concentration; and
utilizing the estimated capacity factors in combination with an optimum capacity factor value, kₒₚₜ, to determine (i) a start gradient solvent volume concentration value, and (ii) an end gradient solvent volume concentration value for the liquid chromatography separation.

2. The method of claim 1, wherein said method comprises:
utilizing the capacity factors, k's, and the first and second solvent volume concentrations to determine parameters (i) k₀ and m or (ii) a and m of at least one equation selected from:
k=k₀φ^{-m} for a normal phase system, and
ln k=a−mφ for a reverse phase system; and
calculating initial start and end gradient solvent volume concentration values, φᵢₛ and φᵢₑ respectively, using an optimum capacity factor value, kₒₚₜ and parameters (i) k₀ and m or (ii) a and m in at least one equation selected from:
φ=[(k₀/kₒₚₜ)^{1/m}] for a normal phase system, and
φ=[(a−ln kₒₚₜ)/m] for a reverse phase system.

3. The method of claim 2, wherein the optimum capacity factor value, kₒₚₜ, is equal to 2.0.

4. The method of claim 2, further comprising:
utilizing the initial start and end gradient solvent volume concentration values, and a gradient duration period value to calculate (i) retention volumes for each elutable compound using at least one equation selected from:
$$\begin{matrix}{V}_{R} = {\frac{1}{B} [ ( m + 1 ) B ( {k}_{0} {V}_{m} - ( {V}_{D} + {V}_{h} ) {A}^{m} ) + {A}^{( m + 1 )} ]}^{1 / m + 1} - \frac{A}{B} + {V}_{m} {V}_{D} + {V}_{h} , \\ and & ( I ) \\ {V}_{R} = ( \frac{1}{mB} ) ln \{ mB [ {V}_{m} {e}^{( a - mA )} - ( {V}_{D} + {V}_{h} ) ] + 1 \} + {V}_{m} + {V}_{D} + {V}_{h} , & ( IV )\end{matrix}$$
wherein:
A=the start gradient volume concentration value;
B=[(the end gradient volume concentration value)−(the start gradient volume concentration value)]/(the gradient duration period value);
Vₘ is a column void volume;
V_{D} is a dwell volume; and
Vₕ is an initial hold volume;
(ii) an average bandwidth of peaks of each elutable compound, w_{g}, using equation II:
w_{g}=2(V₁+V₂)/\sqrt{N} (II),
wherein:
V₁ and V₂ are V_{R} values for elutable compounds 1 and 2 using equation I or IV above; and
N is a column efficiency; and
(iii) a resolution between component peaks using equation III:
Rₛ=(V₂−V₁)/w_{g} (III); and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, said method further comprises providing the initial start and end gradient solvent volume concentration values, and the initial gradient duration value, t_{g}, to a user for review; and
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, said method further comprises initiating a gradient duration period adjustment procedure.

5. The method of claim 4, wherein the gradient duration period adjustment procedure comprises:
(a) increasing the initial gradient duration period value to an increased gradient duration period value;
(b) recalculating (i) retention volumes for each elutable compound using at least one of equations I and IV and the increased gradient duration period value, (ii) the average bandwidth of peaks, w_{g}, using equation II, and (iii) the resolution using equation III;
(c) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, said method further comprises providing the initial start and end gradient solvent volume concentration values, and the increased gradient duration value to the user for review, or
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, said method further comprises repeating steps (a), (b) and (c), wherein steps (a), (b) and (c) are repeated up to a first fixed number of times; and
if the first fixed number of times is reached,
providing the initial start and end gradient solvent volume concentration values, and the increased gradient duration value to the user for review, or
initiating a start gradient solvent volume concentration adjustment procedure.

6. The method of claim 5, wherein said method further comprises said step of initiating the start gradient solvent volume concentration adjustment procedure, wherein said start gradient solvent volume concentration adjustment procedure comprises:
(e) decreasing the start gradient solvent volume concentration to a decreased start gradient solvent volume concentration value;
(f) recalculating (i) retention volumes for each elutable compound using at least one of equations I and IV, the increased gradient duration period value, the decreased start gradient solvent volume concentration value, and the initial end gradient solvent volume concentration value, (ii) the average bandwidth of peaks, w_{g}, using equation II, and (iii) the resolution using equation III;
(g) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, said method further comprises providing the decreased start gradient solvent volume concentration value, the initial end gradient solvent volume concentration value, and the increased gradient duration value to the user for review, or
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, said method further comprises repeating steps (e), (f) and (g), wherein steps (e), (f) and (g) are repeated up to a second fixed number of times; and
if the second fixed number of times is reached,
providing the decreased start gradient solvent volume concentration value, the initial end gradient solvent volume concentration value, and the increased gradient duration value to the user for review, or
initiating an end gradient solvent volume concentration adjustment procedure.

7. The method of claim 6, wherein said method further comprises said step of initiating the end gradient solvent volume concentration adjustment procedure, wherein said end gradient solvent volume concentration adjustment procedure comprises:
(p) decreasing the end gradient solvent volume concentration to a decreased end gradient solvent volume concentration value;
(q) recalculating (i) retention volumes for each elutable compound using at least one of equations I and IV, the increased gradient duration period value, the decreased start gradient solvent volume concentration value, and the decreased end gradient solvent volume concentration value, (ii) the average bandwidth of peaks, w_{g}, using equation II, and (iii) the resolution using equation III;
(r) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, said method further comprises providing the decreased start gradient solvent volume concentration value, the decreased end gradient solvent volume concentration value, and the increased gradient duration value to the user for review, or
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, said method further comprises repeating steps (p), (q) and (r), wherein steps (p), (q) and (r) are repeated up to a third fixed number of times; and
if the third fixed number of times is reached,
providing the decreased start gradient solvent volume concentration value, the decreased end gradient solvent volume concentration value, and the increased gradient duration value to the user for review.

8. The method of claim 7, wherein the initial gradient duration period value is one column volume, each increased gradient duration period value differs from one another by about one column volume, each decreased start gradient solvent volume concentration value comprises about 90% of a previous start gradient solvent volume concentration value, each decreased end gradient solvent volume concentration value comprises about 90% of a previous end gradient solvent volume concentration value, the first fixed number of times is about 10, the second fixed number of times is about 100, and the third fixed number of times is about 100.

9. The method of claim 2, wherein said step of utilizing the capacity factors comprises determining parameters k₀ and m.

10. The method of claim 5, wherein said step of providing the initial start and end gradient solvent volume concentration values, and the increased gradient duration value to the user for review also comprises providing the initial start and end gradient solvent volume concentration values, and the increased gradient duration value to a liquid chromatography separation unit for use in liquid chromatography separation unit software, wherein the liquid chromatography separation unit software is operatively adapted to accept and utilize the initial start and end gradient solvent volume concentration values, and the increased gradient duration value during a liquid chromatography separation procedure.

11. A computer readable medium having stored thereon computer-executable instructions for performing the method of claim 5.

12. A computer readable medium having stored thereon computer-executable instructions for performing the method of claim 8.

13. A liquid chromatography system comprising:
a computing system,
user interface with said computing system, and
programmable instructions or software that enables performance of the method of claim 8.

14. The liquid chromatography system of claim 13, further comprising:
a liquid chromatography separation unit comprising:
a liquid chromatography column,
a fraction collector, and
liquid chromatography separation unit software, wherein the liquid chromatography separation unit software is operatively adapted to accept and utilize one or more optimized process parameters from the computing system while separating a sample in the liquid chromatography column.

15. A liquid chromatography system capable of providing one or more separation parameter values to a user for a liquid chromatography separation, said system comprising:
a computing system, and
a user interface with said computing system,
said computing system being capable of:
utilizing chromatography retention data to estimate capacity factors, k's, of two or more elutable compounds within (i) a first separation comprising a first solvent volume concentration and (ii) a second separation comprising a second solvent volume concentration, wherein the second solvent volume concentration is different than the first solvent volume concentration;
utilizing the estimated capacity factors in combination with an optimum capacity factor value, kₒₚₜ, to determine (i) a start gradient solvent volume concentration value, and (ii) an end gradient solvent volume concentration value for the liquid chromatography separation; and
providing (i) the start gradient solvent volume concentration value, and (ii) the end gradient solvent volume concentration value to the user for review.

16. The liquid chromatography system of claim 15, wherein said user interface comprises a visual display for the user.

17. The liquid chromatography system of claim 15, wherein said computing system is capable of:
utilizing the capacity factors, k, and the first and second solvent volume concentrations to determine parameters (i) k₀ and m or (ii) a and m of at least one equation selected from:
k=k₀φ^{-m} for a normal phase system, and
ln k=a−mφ for a reverse phase system;
calculating initial start and end gradient solvent volume concentration values, φᵢₛ and φᵢₑ respectively, using an optimum capacity factor value, kₒₚₜ and parameters (i) k₀ and m or (ii) a and m in at least one equation selected from:
φ=[(k₀/kₒₚₜ)^{1/m}] for a normal phase system, and
φ=[(a−ln kₒₚₜ)/m] for a reverse phase system;
utilizing the initial start and end gradient solvent volume concentration values, and a gradient duration period value to calculate (i) retention volumes for each elutable compound using at least one equation selected from:
$$\begin{matrix}{V}_{R} = {\frac{1}{B} [ ( m + 1 ) B ( {k}_{0} {V}_{m} - ( {V}_{D} + {V}_{h} ) {A}^{m} ) + {A}^{( m + 1 )} ]}^{1 / m + 1} - \frac{A}{B} + {V}_{m} {V}_{D} + {V}_{h} , \\ and & ( I ) \\ {V}_{R} = ( \frac{1}{mB} ) ln \{ mB [ {V}_{m} {e}^{( a - mA )} - ( {V}_{D} + {V}_{h} ) ] + 1 \} + {V}_{m} + {V}_{D} + {V}_{h} , & ( IV )\end{matrix}$$
wherein:
A=the start gradient volume concentration value;
B=[(the end gradient volume concentration value)−(the start gradient volume concentration value)]/(the gradient duration period value);
Vₘ is a column void volume;
V_{D} is a dwell volume; and
Vₕ is an initial hold volume;
(ii) an average bandwidth of peaks of each elutable compound, w_{g}, using equation II:
w_{g}=2(V₁+V₂)/\sqrt{N} (II),
wherein:
V₁ and V₂ are V_{R} values for elutable compounds 1 and 2 using equation I or IV above; and
N is a column efficiency; and
(iii) a resolution between component peaks using equation III:
Rₛ=(V₂−V₁)/w_{g} (III); and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, providing the initial start and end gradient solvent volume concentration values, and the initial gradient duration value, t_{g}, to a user for review; and
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, either:
providing the initial start and end gradient solvent volume concentration values, and the initial gradient duration value, t_{g}, to a user for review, or
initiating a gradient duration period adjustment procedure.

18. The liquid chromatography system of claim 17, wherein said step of initiating the gradient duration period adjustment procedure comprises:
(a) increasing the initial gradient duration period value to an increased gradient duration period value;
(b) recalculating (i) retention volumes for each elutable compound using at least one of equations I and IV and the increased gradient duration period value, (ii) the average bandwidth of peaks, w_{g}, using equation II, and (iii) the resolution using equation III;
(c) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, providing the initial start and end gradient solvent volume concentration values, and the increased gradient duration value to the user for review, or
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, repeating steps (a), (b) and (c), wherein steps (a), (b) and (c) are repeated up to a first fixed number of times; and
if the first fixed number of times is reached,
providing the initial start and end gradient solvent volume concentration values, and the increased gradient duration value to the user for review, or
initiating a start gradient solvent volume concentration adjustment procedure.

19. The liquid chromatography system of claim 18, wherein said step of initiating the start gradient solvent volume concentration adjustment procedure comprises:
(e) decreasing the start gradient solvent volume concentration to a decreased start gradient solvent volume concentration value;
(f) recalculating (i) retention volumes for each elutable compound using at least one of equations I and IV, the increased gradient duration period value, the decreased start gradient solvent volume concentration value, and the initial end gradient solvent volume concentration value, (ii) the average bandwidth of peaks, w_{g}, using equation II, and (iii) the resolution using equation III;
(g) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, providing the decreased start gradient solvent volume concentration value, the initial end gradient solvent volume concentration value, and the increased gradient duration value to the user for review, or
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, repeating steps (e), (f) and (g), wherein steps (e), (f) and (g) are repeated up to a second fixed number of times; and
if the second fixed number of times is reached,
providing the decreased start gradient solvent volume concentration value, the initial end gradient solvent volume concentration value, and the increased gradient duration value to the user for review, or
initiating an end gradient solvent volume concentration adjustment procedure.

20. The liquid chromatography system of claim 19, wherein said step of initiating the end gradient solvent volume concentration adjustment procedure comprises:
(p) decreasing the end gradient solvent volume concentration to a decreased end gradient solvent volume concentration value;
(q) recalculating (i) retention volumes for each elutable compound using at least one of equations I and IV, the increased gradient duration period value, the decreased start gradient solvent volume concentration value, and the decreased end gradient solvent volume concentration value, (ii) the average bandwidth of peaks, w_{g}, using equation II, and (iii) the resolution using equation
(r) determining whether the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, and
if (1) the two or more elutable compounds are completely eluted as indicated by V₁<Vₘ+Vₕ+V_{D}+V_{G} and V₂<Vₘ+Vₕ+V_{D}+V_{G}, and (2) a resolution Rₛ of at least 1.5 is attained, providing the decreased start gradient solvent volume concentration value, the decreased end gradient solvent volume concentration value, and the increased gradient duration value to the user for review, or
if (1) the two or more elutable compounds are not completely eluted as indicated by V₁<Vₘ+Vₕ+V_{D}+V_{G} and V₂<Vₘ+Vₕ+V_{D}+V_{G} or (2) a resolution Rₛ of at least 1.5 is not attained, repeating steps (p), (q) and (r), wherein steps (p), (q) and (r) are repeated up to a third fixed number of times; and
if the third fixed number of times is reached,
providing the decreased start gradient solvent volume concentration value, the decreased end gradient solvent volume concentration value, and the increased gradient duration value to the user for review.

21. The liquid chromatography system of claim 19, wherein said computing system is further capable of providing (i) an initial or decreased start solvent volume concentration value, (ii) an initial or decreased end gradient solvent volume concentration value, and (iii) the increased gradient duration value to a liquid chromatography separation unit for use in liquid chromatography separation unit software, wherein the liquid chromatography separation unit software is operatively adapted to accept and utilize (i) the initial or decreased start solvent volume concentration value, (ii) the initial or decreased end gradient solvent volume concentration value, and (iii) the increased gradient duration value during a liquid chromatography separation procedure.

22-105. (canceled)
